(19) United States
(12) Patent Application Publication
(10) Pub. No.: US 2026/0051050 A1
(43) Pub. Date: Feb. 19, 2026

(54) MULTI-CLASS IMAGE SEGMENTATION WITH W-NET ARCHITECTURE

(71) Applicants: SMITH & NEPHEW, INC., Memphis, TN (US); SMITH & NEPHEW ORTHOPAEDICS AG, Zug (CH); SMITH & NEPHEW ASIA PACIFIC PTE. LIMITED, Singapore (SG)

(72) Inventors: Darren J. WILSON, Hull Yorkshire (GB); Branislav JARAMAZ, Pittsburgh, PA (US)

(21) Appl. No.: 19/103,889

(22) PCT Filed: Aug. 22, 2023
(86) PCT No.: PCT/US2023/030826

§ 371 Date: Feb. 14, 2025

Related U.S. Application Data
(60) Provisional application No. 63/400,189, filed on Aug. 23, 2022.

(51) Int. Cl. G06T 7/00; B25J 19/02; G06T 7/11

(52) U.S. Cl. CPC G06T 7/0012; B25J 19/021; G06T 7/11; G06T 2207/30008

(57) ABSTRACT

A system for markerless registration and tracking is disclosed. The system includes an imaging sensor configured to capture both RGB images and depth maps of environment. The system can be configured to receive an RGB image and associated depth information from the imaging sensor, segment the RGB image, using a deep learning network, by classifying each pixel as belonging to one of the group of proximal tibia, distal femur, patella, or non-boney material of the knee, and determine a loss based on a comparison between the predicted segmentation mask and a ground-truth mask. The ground-truth mask may be generated based on the depth map captured by the imaging sensor.

### CROSS-REFERENCE TO RELATED APPLICATIONS

This application claims priority to U.S. Provisional Patent Application 63/400,189, titled “MULTI-CLASS IMAGE SEGMENTATION WITH W-NET ARCHITECTURE,” filed on Aug. 23, 2022, which is hereby incorporated by reference herein in its entirety.

### TECHNICAL FIELD

The present disclosure relates generally to methods, systems, and apparatuses related to a computer-assisted surgical system that includes various hardware and software components that work together to enhance surgical workflows. The disclosed techniques may be applied to, for example, shoulder, hip, and knee arthroplasties, as well as other surgical interventions such as arthroscopic procedures, spinal procedures, maxillofacial procedures, rotator cuff procedures, ligament repair and replacement procedures.

### BACKGROUND

Robot-assisted orthopedic surgery is gaining popularity as a tool that can increase the accuracy and repeatability of implant placement and provide quantitative real-time intraoperative metrics. Registration plays an important role in robot-assisted orthopedic surgery, as it defines the position of the patient with respect to the surgical system so that a pre-operative plan can be correctly aligned with the surgical site. All subsequent steps of the procedure are directly affected by the registration accuracy.

Conventionally, two approaches for patient registration are available to the surgeon. In image-based methods, the surgeon uses a tracked probe to manually measure the position of a plurality of points on the target bone “Point Cloud,” which are compared to their corresponding locations on a plan generated from pre-operative images (e.g., Computed Tomography (CT) or Magnetic Resonance Imaging (MRI) to calculate the relative spatial transformations. Conversely, in image-free methods, the geometry of the bone surface is scanned using the probe so that a generic model can be morphed onto it for intra-operative planning purposes, avoiding the need for costly pre-operative imaging.

Current generation surgical navigation platforms rely on reflective markers for bone registration, which require pin insertion and registration point collection that increase procedure time, leading to lower efficiency. Markerless registration and tracking using 3D RGB-Depth cameras, which capture 2D-RGB images along with per-pixel depth information (3D point clouds converted from depth frames), can substantially reduce the amount of manual intervention and eliminate the need for rigidly attached markers.

An RGB-D camera, such as the SpryTrack 300 from Smith & Nephew, Inc., can be configured to output a color map and a depth image, which is a map describing the spatial geometry of the environment. Like RGB images, a depth image is a matrix of pixels, or points, each of which contains three values. However, the values of a pixel are the x, y and z coordinates of that point relative to the depth camera rather than RGB channels. Given that depth images and RGB images share the same data structure, the deep learning network for depth image segmentation can adopt the architectures that perform well on RGB images.

Semantic segmentation is important for medical image analysis as it identifies the target anatomical structure for further diagnosis or a treatment plan. However, selecting a suitably trained deep-learning based segmentation network for intra-operative orthopedic registration with sufficient accuracy is challenging. Furthermore, given that a joint can contain more than one target anatomy (e.g., the knee contains the femur, tibia, and patella) a multi-class image segmentation network is required to auto-segment the surface geometry of the targeted bone for patient registration. To date, no pre-trained multiclass classifications that can fulfill these requirements in orthopedic-robot-assisted surgery for unsupervised image segmentation exist. For markerless patient registration, this type of neural network architecture would allow the 2D-RGB image segmentation and 3D point cloud registration to be optimized simultaneously.

### SUMMARY

In some aspects, the techniques described herein relate to a system for intraoperative multi-class segmentation of a patient's proximal tibia, distal femur, and patella, including: an imaging sensor configured to capture RGB frames and depth data; a processor; and a non-transitory, processor-readable storage medium in communication with the processor, wherein the non-transitory, processor-readable storage medium contains one or more programming instructions that, when executed, cause the processor to: receive an RGB frame and associated depth information from the imaging sensor, segment the RGB frame, using a deep learning network, by classifying each pixel as belonging to one of the group of proximal tibia, distal femur, patella, or non-boney material of the knee, and determine a loss based on a comparison between the predicted segmentation mask and a ground-truth mask.

In some aspects, the techniques described herein relate to a system, wherein the imaging sensor is affixed to a static position above the patient.

In some aspects, the techniques described herein relate to a system, wherein the imaging sensor is affixed to a robotically controlled instrument.

In some aspects, the techniques described herein relate to a system, wherein the imaging sensor is affixed to a robot arm end effector.

In some aspects, the techniques described herein relate to a system, wherein the deep learning network is optimized under real-world occlusion scenarios.

In some aspects, the techniques described herein relate to a system, wherein the loss is a Dice score loss.

In some aspects, the techniques described herein relate to a system, wherein the one or more programming instructions, when executed, further cause the processor to automatically generate the ground-truth mask based on a 3D point cloud.

In some aspects, the techniques described herein relate to a system, wherein the 3D point cloud is based on imagery collected preoperatively.

In some aspects, the techniques described herein relate to a system, wherein the 3D point cloud is based on the depth data collected by the imaging sensor.

In some aspects, the techniques described herein relate to a system, wherein the 3D point cloud is further based on an atlas model.

In some aspects, the techniques described herein relate to a system, wherein the one or more programming instructions, when executed, further cause the processor to locate a bounding around a region of interest, based on the detection based on the segmentation mask.

In some aspects, the techniques described herein relate to a system, wherein the one or more programming instructions, when executed, cause the processor to segment the RGB frame, using a deep learning network, by classifying each pixel as belonging to one of the group of proximal tibia, distal femur, patella, or non-boney material of the knee further includes one or more programming instructions that, when executed, cause the processor to classify each pixel as resected or non-resected.

In some aspects, the techniques described herein relate to a system, wherein the one or more programming instructions, when executed, further cause the processor to generate a 3D point cloud based on the depth data; construct a 3D surface of the patient anatomy by applying the segmentation to the 3D point cloud; and determine a pose of at least one of the patient's proximal tibia, distal femur, and patella, by aligning the 3D surface of the at least one of the patient's proximal tibia, distal femur, and patella with at least one of a 3D pre-operative model of the patient or an atlas model.

In some aspects, the techniques described herein relate to a system, wherein the one or more programming instructions, when executed, further cause the processor to determine a location of a landmark region associated with the proximal tibia, distal femur, or patella.

In some aspects, the techniques described herein relate to a system, wherein the landmark is localized in preoperative imagery.

In some aspects, the techniques described herein relate to a system, wherein the one or more programming instructions that, when executed, cause the processor to determine a location of a landmark region associated with the proximal tibia, distal femur, or patella further include one or more programming instructions that, when executed, cause the processor to generate a heat map estimation of the landmark; and determine a location of the landmark based on the heat map estimation,

In some aspects, the techniques described herein relate to a system, wherein the one or more programming instructions that, when executed, cause the processor to determine a location of a landmark region associated with the proximal tibia, distal femur, or patella further include one or more programming instructions that, when executed, cause the processor to regress the landmark region into at least one of a point or line.

In some aspects, the techniques described herein relate to a system, wherein the landmark is at least one of the patella centroid, the patella poles, Whiteside's line, the anterior-posterior axis, the femur's knee center, or the tibia's knee center.

In some aspects, the techniques described herein relate to a system, wherein the one or more programming instructions, when executed, further cause the processor to align at least one of a cut guide or implant based on the location of the landmark.

In some aspects, the techniques described herein relate to a method of determining a pose patient anatomy including: receiving imagery from an imaging sensor, wherein the imaging sensor produces RGB images and associated depth data; segmenting the imagery based on the patient anatomy visible in the imagery, wherein segmenting includes classifying any of a femur, tibia, or patella present in the imagery; generating a 3D point cloud based on the depth data; constructing a 3D surface of the patient anatomy by applying the segmentation to the 3D point cloud; and determining a pose of the patient anatomy by aligning the 3D surface of the patient anatomy with at least one of a 3D pre-operative model of the patient or an atlas model.

### BRIEF DESCRIPTION OF THE DRAWINGS

The accompanying drawings, which are incorporated in and form a part of the specification, illustrate the embodiments of the invention and together with the written description serve to explain the principles, characteristics, and features of the invention. In the drawings:

FIG. 1 depicts an illustrative computer-assisted surgical system in accordance with an embodiment.

FIG. 2A depicts a comparison of parameters between the U-Net and E-Net architectures in accordance with an embodiment.

FIG. 2B illustrates the E-Net architecture in accordance with an embodiment.

FIG. 2C illustrates the U-Net architecture in accordance with an embodiment.

FIG. 3A depicts an example of occlusion resulting from a surgeon's hand in accordance with an embodiment.

FIG. 3B depicts an example of occlusion resulting from a surgical tool in accordance with an embodiment.

FIG. 4A illustrates an image-based registration method in accordance with an embodiment.

FIG. 4B illustrates an imageless registration method in accordance with an embodiment.

FIG. 5 depicts an RGB-D imaging sensor in accordance with an embodiment.

FIG. 6 depicts the dual mode functionality of an RGB-D imaging sensor in accordance with an embodiment.

FIG. 7A illustrates a binary classification neural network, based upon a U-Net architecture, in accordance with an embodiment.

FIG. 7B depicts an example input image for a neural network in accordance with an embodiment.

FIG. 7C depicts an example predicted segmentation mask based on the input in FIG. 7B in accordance with an embodiment.

FIG. 7D depicts a mask based on ground-truth data associated with the example input in FIG. 7B in accordance with an embodiment.

FIG. 7E depicts the overlay between the example predicted segmentation mask of FIG. 7C and the ground-truth mask of FIG. 7D in accordance with an embodiment.

FIG. 8A illustrates a multi-class classification neural network based on the U-Net architecture in accordance with an embodiment.

FIG. 8B depicts an example input image including a distal femur and proximal tibia in accordance with an embodiment.

FIG. 8C depicts the predicted segmentation masks, based on the input of FIG. 8B, individually segmenting the distal femur and the proximal tibia in accordance with an embodiment.

FIG. 8D depicts ground-truth masks of the distal femur and the proximal tibia associated with the example input of FIG. 8B in accordance with an embodiment.

FIG. 9A depicts an example input image of a patella in accordance with an embodiment.

FIG. 9B depicts the predicted segmentation mask of the patella input in FIG. 9A in accordance with an embodiment.

FIG. 9C depicts ground-truth masking associated with the input of FIG. 9A in accordance with an embodiment.

FIG. 9D depicts an overlay comparing the predicted segmentation mask of FIG. 9B and the ground-truth masking of FIG. 9C in accordance with an embodiment.

FIG. 10 illustrates a short-listed objection detection model in accordance with an embodiment.

FIG. 11A illustrates automatic ground truth generation for knee detection in accordance with an embodiment.

FIG. 11B depicts an example real-time display of a knee in accordance with an embodiment.

FIG. 12A illustrates a best-fit anterior plane guide in accordance with an embodiment.

FIG. 12B depicts a display for aiding in bone removal on the patella in accordance with an embodiment.

FIG. 13A illustrates automatic landmark detection for defining an ankle center in accordance with an embodiment.

FIG. 13B illustrates automatic landmark detection for defining a knee center in accordance with an embodiment.

FIG. 13C illustrates automatic landmark detection for defining a hip center in accordance with an embodiment.

FIG. 14 illustrates a method for automatically generating ground-truth masking for both binary and multi-class classification networks in accordance with an embodiment.

FIG. 15 illustrates strategies for improving the overall accuracy of the auto-segmentation deep learning network, in 3D space, for both the binary and multi-class classification approaches in accordance with an embodiment.

FIG. 16 illustrates the application of 2D segmentation in 3D registration in accordance with an embodiment.

FIG. 17 illustrates the W-Net model as applied to segmentation in accordance with an embodiment.

FIG. 18 illustrates the real-time registration architecture required for accuracy testing in accordance with an embodiment.

FIG. 19A-D illustrates the real-time registration hierarchical architecture for the deep learning pipeline in accordance with an embodiment.

FIGS. 20A-C depict illustrative Dice box plots, from three example folds, obtained from the multi-class architecture to perform a combined femur and tibia segmentation in accordance with an embodiment.

FIGS. 21A-C depict illustrative Dice box plots, from three example folds, obtained from the multi-class architecture to perform tibia segmentation in accordance with an embodiment.

FIGS. 22A-C depict illustrative Dice box plots, from three example folds, obtained from the multi-class architecture to perform femur segmentation in accordance with an embodiment.

FIG. 23A depicts an illustrative Dice box plot obtained from the multi-class architecture to perform femur segmentation with an overfitted model including manually annotated images in accordance with an embodiment.

FIG. 23B depicts an illustrative Dice box plot obtained from the multi-class architecture to perform tibia segmentation with an overfitted model including manually annotated images in accordance with an embodiment.

FIG. 24A depicts illustrative Dice box plots obtained from the multi-class architecture to perform femur segmentation comparing an initial model and a model fine-tuned with manual ground-truths in accordance with an embodiment.

FIG. 24B depicts illustrative Dice box plots obtained from the multi-class architecture to perform tibia segmentation comparing an initial model and a model fine-tuned with manual ground-truths in accordance with an embodiment.

FIG. 25A depicts illustrative Dice box plots obtained from the multi-class architecture to perform femur segmentation comparing performance of the model at segmenting images with and without occlusion in accordance with an embodiment.

FIG. 25B depicts illustrative Dice box plots obtained from the multi-class architecture to perform tibia segmentation comparing performance of the model at segmenting images with and without occlusion in accordance with an embodiment.

FIG. 26 depicts a block diagram of a data processing system in accordance with an embodiment.

### DETAILED DESCRIPTION

This disclosure is not limited to the particular systems, devices and methods described, as these may vary. The terminology used in the description is for the purpose of describing the particular versions or embodiments only and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

### Definitions

For the purposes of this disclosure, the term “implant” is used to refer to a prosthetic device or structure manufactured to replace or enhance a biological structure. For example, in a total hip replacement procedure, a prosthetic acetabular cup (implant) is used to replace or enhance a patient's worn or damaged acetabulum. While the term “implant” is generally considered to denote a man-made structure (as contrasted with a transplant), for the purposes of this specification an implant can include a biological tissue or material transplanted to replace or enhance a biological structure.

For the purposes of this disclosure, the term “real-time” is used to refer to calculations or operations performed on-the-fly as events occur or input is received by the operable system. However, the use of the term “real-time” is not intended to preclude operations that cause some latency between input and response, so long as the latency is an unintended consequence induced by the performance characteristics of the machine.

Although much of this disclosure refers to surgeons or other medical professionals by specific job title or role, nothing in this disclosure is intended to be limited to a specific job title or function. Surgeons or medical professionals can include any doctor, nurse, medical professional, or technician. Any of these terms or job titles can be used interchangeably with the user of the systems disclosed herein unless otherwise explicitly demarcated. For example, a reference to a surgeon also could apply, in some embodiments, to a technician or nurse.

The systems, methods, and devices disclosed herein are particularly well adapted for surgical procedures that utilize surgical navigation systems, such as the CORI® surgical navigation system. CORI is a registered trademark of BLUE BELT TECHNOLOGIES, INC. of Pittsburgh, PA, which is a subsidiary of SMITH & NEPHEW, INC. of Memphis, TN.

### CASS Ecosystem Overview

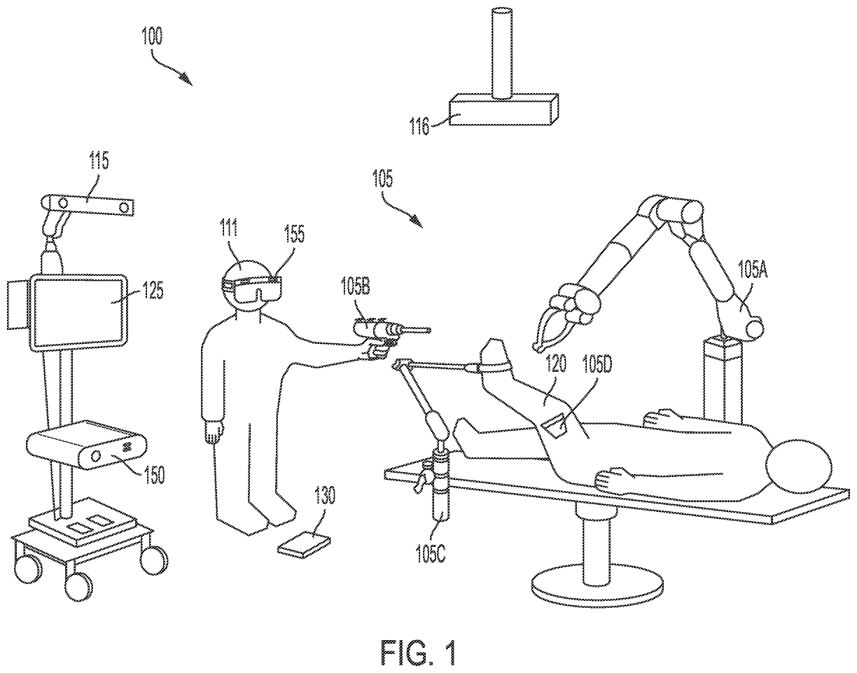

FIG. 1 provides an illustration of an example computer-assisted surgical system (CASS) 100, according to some embodiments. As described in further detail in the sections that follow, the CASS uses computers, robotics, and imaging technology to aid surgeons in performing orthopedic surgery procedures such as total knee arthroplasty (TKA) or total hip arthroplasty (THA). For example, surgical navigation systems can aid surgeons in locating patient anatomical structures, guiding surgical instruments, and implanting medical devices with a high degree of accuracy. Surgical navigation systems such as the CASS 100 often employ various forms of computing technology to perform a wide variety of standard and minimally invasive surgical procedures and techniques. Moreover, these systems allow surgeons to more accurately plan, track and navigate the placement of instruments and implants relative to the body of a patient, as well as conduct pre-operative and intra-operative body imaging.

An Effector Platform 105 positions surgical tools relative to a patient during surgery. The exact components of the Effector Platform 105 will vary, depending on the embodiment employed. For example, for a knee surgery, the Effector Platform 105 may include an End Effector 105B that holds surgical tools or instruments during their use. The End Effector 105B may be a handheld device or instrument used by the surgeon (e.g., a CORI® hand piece or a cutting guide or jig) or, alternatively, the End Effector 105B can include a device or instrument held or positioned by a Robotic Arm 105A. While one Robotic Arm 105A is illustrated in FIG. 1, in some embodiments there may be multiple devices. As examples, there may be one Robotic Arm 105A on each side of an operating table T or two devices on one side of the table T. The Robotic Arm 105A may be mounted directly to the table T, be located next to the table T on a floor platform (not shown), mounted on a floor-to-ceiling pole, or mounted on a wall or ceiling of an operating room. The floor platform may be fixed or moveable. In one particular embodiment, the robotic arm 105A is mounted on a floor-to-ceiling pole located between the patient's legs or feet. In some embodiments, the End Effector 105B may include a suture holder or a stapler to assist in closing wounds. Further, in the case of two robotic arms 105A, the surgical computer 150 can drive the robotic arms 105A to work together to suture the wound at closure. Alternatively, the surgical computer 150 can drive one or more robotic arms 105A to staple the wound at closure.

The Effector Platform 105 can include a Limb Positioner 105C for positioning the patient's limbs during surgery. One example of a Limb Positioner 105C is the SMITH AND NEPHEW SPIDER2 system. The Limb Positioner 105C may be operated manually by the surgeon or alternatively change limb positions based on instructions received from the Surgical Computer 150 (described below). While one Limb Positioner 105C is illustrated in FIG. 1, in some embodiments there may be multiple devices. As examples, there may be one Limb Positioner 105C on each side of the operating table T or two devices on one side of the table T. The Limb Positioner 105C may be mounted directly to the table T, be located next to the table T on a floor platform (not shown), mounted on a pole, or mounted on a wall or ceiling of an operating room. In some embodiments, the Limb Positioner 105C can be used in non-conventional ways, such as a retractor or specific bone holder. The Limb Positioner 105C may include, as examples, an ankle boot, a soft tissue clamp, a bone clamp, or a soft-tissue retractor spoon, such as a hooked, curved, or angled blade. In some embodiments, the Limb Positioner 105C may include a suture holder to assist in closing wounds.

The Effector Platform 105 may include tools, such as a screwdriver, light or laser, to indicate an axis or plane, bubble level, pin driver, pin puller, plane checker, pointer, finger, or some combination thereof.

Resection Equipment 110 (not shown in FIG. 1) performs bone or tissue resection using, for example, mechanical, ultrasonic, or laser techniques. Examples of Resection Equipment 110 include drilling devices, burring devices, oscillatory sawing devices, vibratory impaction devices, reamers, ultrasonic bone cutting devices, radio frequency ablation devices, reciprocating devices (such as a rasp or broach), and laser ablation systems. In some embodiments, the Resection Equipment 110 is held and operated by the surgeon during surgery. In other embodiments, the Effector Platform 105 may be used to hold the Resection Equipment 110 during use.

The Effector Platform 105 also can include a cutting guide or jig 105D that is used to guide saws or drills used to resect tissue during surgery. Such cutting guides 105D can be formed integrally as part of the Effector Platform 105 or Robotic Arm 105A. Alternatively, cutting guides 105D can be separate structures that are matingly and/or removably attached to the Effector Platform 105 or Robotic Arm 105A. The Effector Platform 105 or Robotic Arm 105A can be controlled by the CASS 100 to position a cutting guide or jig 105D adjacent to the patient's anatomy in accordance with a pre-operatively or intraoperatively developed surgical plan such that the cutting guide or jig will produce a precise bone cut in accordance with the surgical plan.

The Tracking System 115 uses one or more sensors to collect real-time position data that locates the patient's anatomy and surgical instruments. For example, for TKA procedures, the Tracking System may provide a location and orientation of the End Effector 105B during the procedure. In addition to positional data, data from the Tracking System 115 also can be used to infer velocity/acceleration of anatomy/instrumentation, which can be used for tool control. In some embodiments, the Tracking System 115 may use a tracker array attached to the End Effector 105B to determine the location and orientation of the End Effector 105B. The position of the End Effector 105B may be inferred based on the position and orientation of the Tracking System 115 and a known relationship in three-dimensional space between the Tracking System 115 and the End Effector 105B. Various types of tracking systems may be used in various embodiments of the present invention including, without limitation, Infrared (IR) tracking systems, electromagnetic (EM) tracking systems, video or image based tracking systems, and ultrasound registration and tracking systems. Using the data provided by the tracking system 115, the surgical computer 150 can detect objects and prevent collision. For example, the surgical computer 150 can prevent the Robotic Arm 105A and/or the End Effector 105B from colliding with soft tissue.

Any suitable tracking system can be used for tracking surgical objects and patient anatomy in the surgical theatre. For example, a combination of IR and visible light cameras can be used in an array. Various illumination sources, such as an IR LED light source, can illuminate the scene allowing three-dimensional imaging to occur. In some embodiments, this can include stereoscopic, tri-scopic, quad-scopic, etc. imaging. In addition to the camera array, which in some embodiments is affixed to a cart, additional cameras can be placed throughout the surgical theatre. For example, handheld tools or headsets worn by operators/surgeons can include imaging capability that communicates images back to a central processor to correlate those images with images captured by the camera array. This can give a more robust image of the environment for modeling using multiple perspectives. Furthermore, some imaging devices may be of suitable resolution or have a suitable perspective on the scene to pick up information stored in quick response (QR) codes or barcodes. This can be helpful in identifying specific objects not manually registered with the system. In some embodiments, the camera may be mounted on the Robotic Arm 105A.

In some embodiments, specific objects can be manually registered by a surgeon with the system preoperatively or intraoperatively. For example, by interacting with a user interface, a surgeon may identify the starting location for a tool or a bone structure. By tracking fiducial marks associated with that tool or bone structure, or by using other conventional image tracking modalities, a processor may track that tool or bone as it moves through the environment in a three-dimensional model.

In some embodiments, certain markers, such as fiducial marks that identify individuals, important tools, or bones in the theater may include passive or active identifiers that can be picked up by a camera or camera array associated with the tracking system. For example, an IR LED can flash a pattern that conveys a unique identifier to the source of that pattern, providing a dynamic identification mark. Similarly, one or two dimensional optical codes (barcode, QR code, etc.) can be affixed to objects in the theater to provide passive identification that can occur based on image analysis. If these codes are placed asymmetrically on an object, they also can be used to determine an orientation of an object by comparing the location of the identifier with the extents of an object in an image. For example, a QR code may be placed in a corner of a tool tray, allowing the orientation and identity of that tray to be tracked. Other tracking modalities are explained throughout. For example, in some embodiments, augmented reality headsets can be worn by surgeons and other staff to provide additional camera angles and tracking capabilities.

In addition to optical tracking, certain features of objects can be tracked by registering physical properties of the object and associating them with objects that can be tracked, such as fiducial marks fixed to a tool or bone. For example, a surgeon may perform a manual registration process whereby a tracked tool and a tracked bone can be manipulated relative to one another. By impinging the tip of the tool against the surface of the bone, a three-dimensional surface can be mapped for that bone that is associated with a position and orientation relative to the frame of reference of that fiducial mark. By optically tracking the position and orientation (pose) of the fiducial mark associated with that bone, a model of that surface can be tracked with an environment through extrapolation.

The registration process that registers the CASS 100 to the relevant anatomy of the patient also can involve the use of anatomical landmarks, such as landmarks on a bone or cartilage. For example, the CASS 100 can include a 3D model of the relevant bone or joint and the surgeon can intraoperatively collect data regarding the location of bony landmarks on the patient's actual bone using a probe that is connected to the CASS. Bony landmarks can include, for example, the medial malleolus and lateral malleolus, the ends of the proximal femur and distal tibia, and the center of the hip joint. The CASS 100 can compare and register the location data of bony landmarks collected by the surgeon with the probe with the location data of the same landmarks in the 3D model. Alternatively, the CASS 100 can construct a 3D model of the bone or joint without pre-operative image data by using location data of bony landmarks and the bone surface that are collected by the surgeon using a CASS probe or other means. The registration process also can include determining various axes of a joint. For example, for a TKA the surgeon can use the CASS 100 to determine the anatomical and mechanical axes of the femur and tibia. The surgeon and the CASS 100 can identify the center of the hip joint by moving the patient's leg in a spiral direction (i.e., circumduction) so the CASS can determine where the center of the hip joint is located.

A Tissue Navigation System 120 (not shown in FIG. 1) provides the surgeon with intraoperative, real-time visualization for the patient's bone, cartilage, muscle, nervous, and/or vascular tissues surrounding the surgical area. Examples of systems that may be employed for tissue navigation include fluorescent imaging systems and ultrasound systems.

The Display 125 provides graphical user interfaces (GUIs) that display images collected by the Tissue Navigation System 120 as well other information relevant to the surgery. For example, in one embodiment, the Display 125 overlays image information collected from various modalities (e.g., CT, MRI, X-ray, fluorescent, ultrasound, etc.) collected pre-operatively or intra-operatively to give the surgeon various views of the patient's anatomy as well as real-time conditions. The Display 125 may include, for example, one or more computer monitors. As an alternative or supplement to the Display 125, one or more members of the surgical staff may wear an Augmented Reality (AR) Head Mounted Device (HMD). For example, in FIG. 1 the Surgeon 111 is wearing an AR HMD 155 that may, for example, overlay pre-operative image data on the patient or provide surgical planning suggestions. Various example uses of the AR HMD 155 in surgical procedures are detailed in the sections that follow.

Surgical Computer 150 provides control instructions to various components of the CASS 100, collects data from those components, and provides general processing for various data needed during surgery. In some embodiments, the Surgical Computer 150 is a general purpose computer. In other embodiments, the Surgical Computer 150 may be a parallel computing platform that uses multiple central processing units (CPUs) or graphics processing units (GPU) to perform processing. In some embodiments, the Surgical Computer 150 is connected to a remote server over one or more computer networks (e.g., the Internet). The remote server can be used, for example, for storage of data or execution of computationally intensive processing tasks.

Various techniques generally known in the art can be used for connecting the Surgical Computer 150 to the other components of the CASS 100. Moreover, the computers can connect to the Surgical Computer 150 using a mix of technologies. For example, the End Effector 105B may connect to the Surgical Computer 150 over a wired (i.e., serial) connection. The Tracking System 115, Tissue Navigation System 120, and Display 125 can similarly be connected to the Surgical Computer 150 using wired connections. Alternatively, the Tracking System 115, Tissue Navigation System 120, and Display 125 may connect to the Surgical Computer 150 using wireless technologies such as, without limitation, Wi-Fi, Bluetooth, Near Field Communication (NFC), or ZigBee.

### Robotic Arm

In some embodiments, the CASS 100 includes a robotic arm 105A that serves as an interface to stabilize and hold a variety of instruments used during the surgical procedure. For example, in the context of a hip surgery, these instruments may include, without limitation, retractors, a sagittal or reciprocating saw, the reamer handle, the cup impactor, the broach handle, and the stem inserter. The robotic arm 105A may have multiple degrees of freedom (like a Spider device), and have the ability to be locked in place (e.g., by a press of a button, voice activation, a surgeon removing a hand from the robotic arm, or other method).

In some embodiments, movement of the robotic arm 105A may be effectuated by use of a control panel built into the robotic arm system. For example, a display screen may include one or more input sources, such as physical buttons or a user interface having one or more icons, that direct movement of the robotic arm 105A. The surgeon or other healthcare professional may engage with the one or more input sources to position the robotic arm 105A when performing a surgical procedure.

A tool or an end effector 105B attached or integrated into a robotic arm 105A may include, without limitation, a burring device, a scalpel, a cutting device, a retractor, a joint tensioning device, or the like. In embodiments in which an end effector 105B is used, the end effector may be positioned at the end of the robotic arm 105A such that any motor control operations are performed within the robotic arm system. In embodiments in which a tool is used, the tool may be secured at a distal end of the robotic arm 105A, but motor control operation may reside within the tool itself.

The robotic arm 105A may be motorized internally to both stabilize the robotic arm, thereby preventing it from falling and hitting the patient, surgical table, surgical staff, etc., and to allow the surgeon to move the robotic arm without having to fully support its weight. While the surgeon is moving the robotic arm 105A, the robotic arm may provide some resistance to prevent the robotic arm from moving too fast or having too many degrees of freedom active at once. The position and the lock status of the robotic arm 105A may be tracked, for example, by a controller or the Surgical Computer 150.

In some embodiments, the robotic arm 105A can be moved by hand (e.g., by the surgeon) or with internal motors into its ideal position and orientation for the task being performed. In some embodiments, the robotic arm 105A may be enabled to operate in a “free” mode that allows the surgeon to position the arm into a desired position without being restricted. While in the free mode, the position and orientation of the robotic arm 105A may still be tracked as described above. In one embodiment, certain degrees of freedom can be selectively released upon input from user (e.g., surgeon) during specified portions of the surgical plan tracked by the Surgical Computer 150. Designs in which a robotic arm 105A is internally powered through hydraulics or motors or provides resistance to external manual motion through similar means can be described as powered robotic arms, while arms that are manually manipulated without power feedback, but which may be manually or automatically locked in place, may be described as passive robotic arms.

A robotic arm 105A or end effector 105B can include a trigger or other means to control the power of a saw or drill. Engagement of the trigger or other means by the surgeon can cause the robotic arm 105A or end effector 105B to transition from a motorized alignment mode to a mode where the saw or drill is engaged and powered on. Additionally, the CASS 100 can include a foot pedal 130 that causes the system to perform certain functions when activated. For example, the surgeon can activate the foot pedal 130 to instruct the CASS 100 to place the robotic arm 105A or end effector 105B in an automatic mode that brings the robotic arm or end effector into the proper position with respect to the patient's anatomy in order to perform the necessary resections. The CASS 100 also can place the robotic arm 105A or end effector 105B in a collaborative mode that allows the surgeon to manually manipulate and position the robotic arm or end effector into a particular location. The collaborative mode can be configured to allow the surgeon to move the robotic arm 105A or end effector 105B medially or laterally, while restricting movement in other directions. As discussed, the robotic arm 105A or end effector 105B can include a cutting device (saw, drill, and burr) or a cutting guide or jig 105D that will guide a cutting device. In other embodiments, movement of the robotic arm 105A or robotically controlled end effector 105B can be controlled entirely by the CASS 100 without any, or with only minimal, assistance or input from a surgeon or other medical professional. In still other embodiments, the movement of the robotic arm 105A or robotically controlled end effector 105B can be controlled remotely by a surgeon or other medical professional using a control mechanism separate from the robotic arm or robotically controlled end effector device, for example using a joystick or interactive monitor or display control device.

The examples below describe uses of the robotic device in the context of a hip surgery; however, it should be understood that the robotic arm may have other applications for surgical procedures involving knees, shoulders, etc. One example of use of a robotic arm in the context of forming an anterior cruciate ligament (ACL) graft tunnel is described in WIPO Publication No. WO 2020/047051, filed Aug. 28, 2019, entitled “Robotic Assisted Ligament Graft Placement and Tensioning,”the entirety of which is incorporated herein by reference.

A robotic arm 105A may be used for holding the retractor. For example in one embodiment, the robotic arm 105A may be moved into the desired position by the surgeon. At that point, the robotic arm 105A may lock into place. In some embodiments, the robotic arm 105A is provided with data regarding the patient's position, such that if the patient moves, the robotic arm can adjust the retractor position accordingly. In some embodiments, multiple robotic arms may be used, thereby allowing multiple retractors to be held or for more than one activity to be performed simultaneously (e.g., retractor holding & reaming).

The robotic arm 105A may also be used to help stabilize the surgeon's hand while making a femoral neck cut. In this application, control of the robotic arm 105A may impose certain restrictions to prevent soft tissue damage from occurring. For example, in one embodiment, the Surgical Computer 150 tracks the position of the robotic arm 105A as it operates. If the tracked location approaches an area where tissue damage is predicted, a command may be sent to the robotic arm 105A causing it to stop. Alternatively, where the robotic arm 105A is automatically controlled by the Surgical Computer 150, the Surgical Computer may ensure that the robotic arm is not provided with any instructions that cause it to enter areas where soft tissue damage is likely to occur. The Surgical Computer 150 may impose certain restrictions on the surgeon to prevent the surgeon from reaming too far into the medial wall of the acetabulum or reaming at an incorrect angle or orientation.

In some embodiments, the robotic arm 105A may be used to hold a cup impactor at a desired angle or orientation during cup impaction. When the final position has been achieved, the robotic arm 105A may prevent any further seating to prevent damage to the pelvis.

The surgeon may use the robotic arm 105A to position the broach handle at the desired position and allow the surgeon to impact the broach into the femoral canal at the desired orientation. In some embodiments, once the Surgical Computer 150 receives feedback that the broach is fully seated, the robotic arm 105A may restrict the handle to prevent further advancement of the broach.

The robotic arm 105A may also be used for resurfacing applications. For example, the robotic arm 105A may stabilize the surgeon while using traditional instrumentation and provide certain restrictions or limitations to allow for proper placement of implant components (e.g., guide wire placement, chamfer cutter, sleeve cutter, plan cutter, etc.). Where only a burr is employed, the robotic arm 105A may stabilize the surgeon's handpiece and may impose restrictions on the handpiece to prevent the surgeon from removing unintended bone in contravention of the surgical plan.

The robotic arm 105A may be a passive arm. As an example, the robotic arm 105A may be a CIRQ robot arm available from Brainlab AG. CIRQ is a registered trademark of Brainlab AG, Olof-Palme-Str. 9 81829, München, FED REP of GERMANY. In one particular embodiment, the robotic arm 105A is an intelligent holding arm as disclosed in U.S. patent application Ser. No. 15/525,585 to Krinninger et al., U.S. patent application Ser. No. 15/561,042 to Nowatschin et al., U.S. patent application Ser. No. 15/561,048 to Nowatschin et al., and U.S. Pat. No. 10,342,636 to Nowatschin et al., the entire contents of each of which is herein incorporated by reference.

### RGB-Depth Camera

Referring back to FIG. 1, the CASS 100 uses computers, robotics, and imaging technology to aid surgeons in performing surgical procedures. The CASS 100 can aid surgeons in locating patient anatomical structures, guiding surgical instruments, and implanting medical devices with a high degree of accuracy. Surgical navigation systems such as the CASS 100 often employ various forms of computing technology to perform a wide variety of standard and minimally invasive surgical procedures and techniques. Moreover, these systems allow surgeons to plan, track, and navigate the placement of instruments and implants relative to the body of a patient, as well as conduct pre-operative and intra-operative body imaging.

The CASS 100 includes an optical tracking system 115 in some examples, which uses one or more sensors to collect real-time position data that locates the anatomy of the patient 120 and surgical instruments such as a resection tool 105B in the surgical environment. The one or more sensors can include an RGB-Depth (RGB-D) camera configured to capture both color and depth imaging simultaneously. Because these images are captured simultaneously, the color (i.e., RGB) images and the depth images correspond to each other on a 1:1 basis. Furthermore, because each image captures the patient at the same time from the same orientation, both images can be used interchangeably in a registration process.

### Image Segmentation

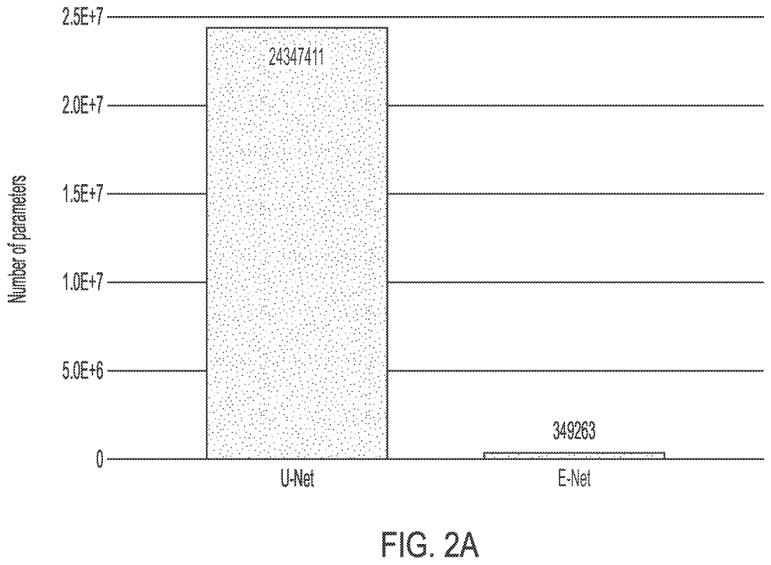

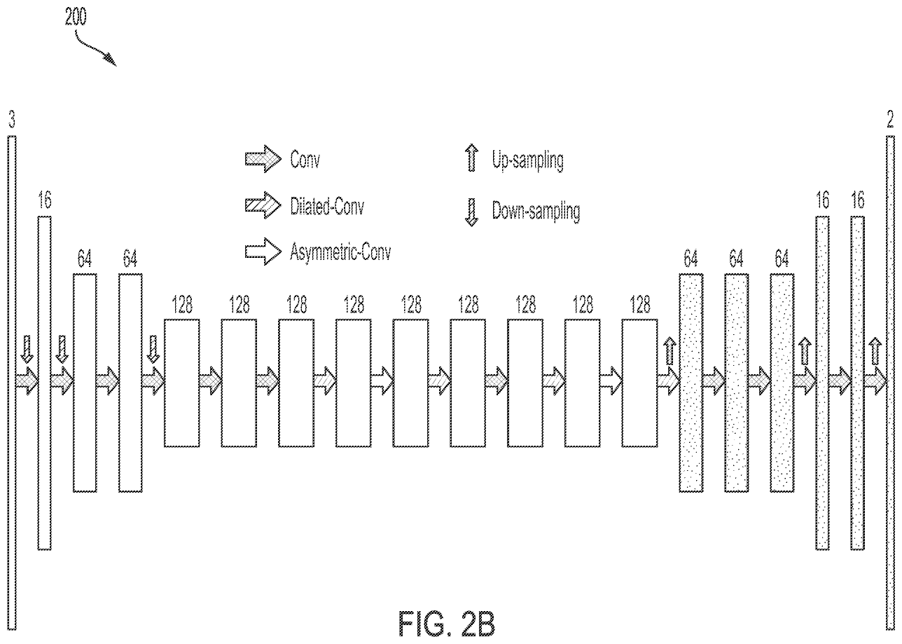

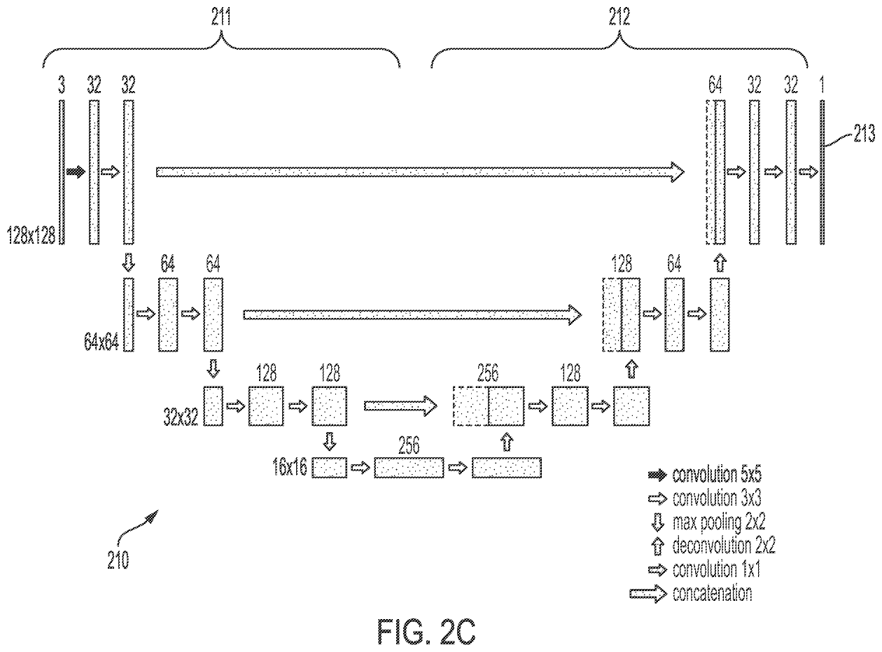

A deep learning network constructed for depth image segmentation can adopt either an E-Net or a U-Net architecture. An E-Net architecture is typically less accurate than a U-Net architecture with respect to image segmentation, but utilizes a more compact encoder-decoder architecture for feature extraction resulting in a 100-fold decrease in trainable parameters. FIG. 2A illustrates the difference in trainable parameters between the U-Net and E-Net architectures. FIG. 2B illustrates the E-Net architecture 200. FIG. 2C illustrates the U-Net architecture 210, which is a fully convolutional network that has a symmetric U shape. The U-Net architecture 210 has the benefit of performing well in the task of medical image segmentation when trained with a relatively small number of images. The U-Net neural network 210 presents a symmetric architecture, includes two stages, and can be composed by down-convolutional and up-convolutional paths. The U-Net neural network 210 is a fully convolutional neural network for fast and precise segmentation of images. The U-Net architecture 210 includes standard convolutional and pooling layers 211 that increase features and contrast resolution and deconvolutional layers 212 to increase resolution, which are then concatenated with high resolution features from the standard convolutional and pooling layers 211 to assemble a more precise output 213. This ultimately yields the binary segmentation masks. The last layer can be a 1×1 convolutional layer with a sigmoid activation, which maps all the features of a pixel to a value between 0 and 1. The value can represent the probability of the given pixel belonging to a classification (e.g., the probability that a pixel is part of a femur). A loss function can be defined as the mean of the squared pixel errors. The network used for training can be implemented using any known method, including but not limited to, TensorFlow and the Adam optimizer.

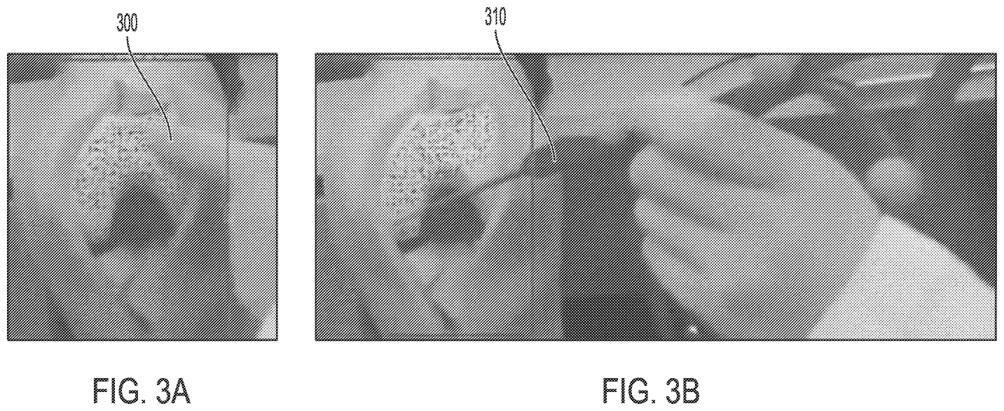

An image segmentation model in a surgical environment should not only function on a clean target surface but also remain robust when the target is manipulated under occlusion. FIGS. 3A and 3B illustrate example occlusion scenarios in a surgical environment. FIG. 3A depicts the surgeon's finger 300 occluding a portion of the visible bone surface. FIG. 3B depicts a surgical tool 310 occluding a portion of the visible bone surface. Other sources of occlusion may include portions of the patient's anatomy, blood, and light changes. Training a model to perform image segmentation with an occluded target can include generating a synthetic dataset to train a segmentation network with a revised architecture under real-world occlusion caused by intraoperative interventions.

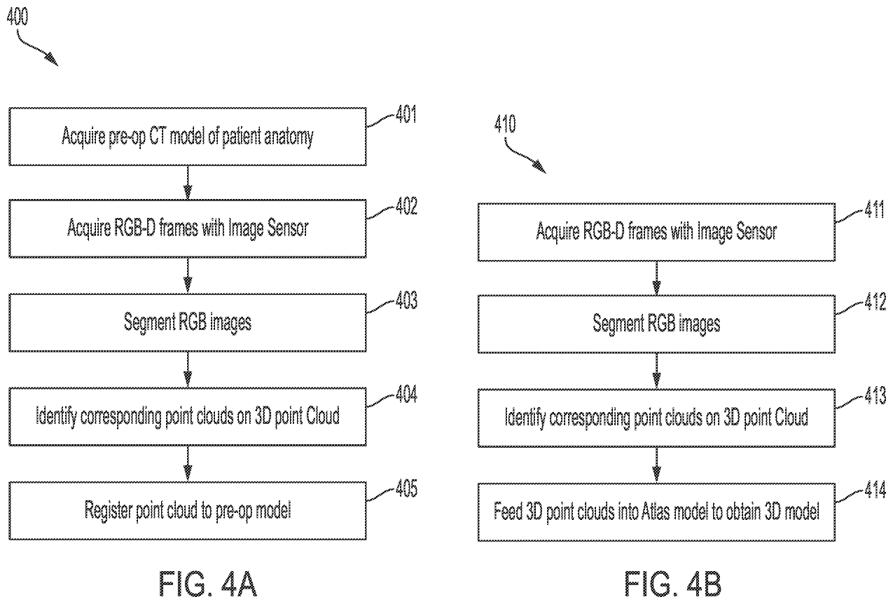

A deep learning model can be configured for end-to-end intra-operative image segmentation during robot-assisted orthopedic surgery. A training set can include labelled RGB-D images of anatomy (e.g., cadaveric knees). The deep learning model can be configured to perform image-based registration and/or imageless registration. FIG. 4A depicts a workflow for image-based registration 400. The image-based registration 400 can include acquiring a pre-operative model of the patient anatomy 401 based on imaging. Intraoperatively, the image-based registration 400 can include acquiring RGB-D frame with an image sensor 402, segmenting the images 403, identifying corresponding point clouds on a 3D point cloud 404, and registering the point clouds to the pre-operative model 405. FIG. 4B depicts a workflow for imageless registration 410. Imageless registration 410 can include acquiring RGB-D frame with an image sensor 411. The frames can be captured at high frame rates when compared to other systems (e.g., >25 Hz). Imageless registration 410 can include segmenting the RGB images 412. Segmentation can include a multi-class deep learning approach as described herein. Imageless registration 410 identifies corresponding point clouds on a 3D point cloud 413 in a similar manner to the image-based 400 registration. The 3D point clouds can be fed into an atlas model to obtain an 3D model 414. The atlas model can be modified based on intraoperative imaging to more closely mirror the patient anatomy.

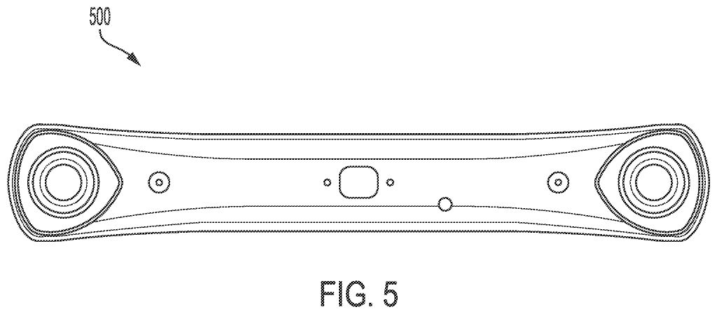

The network architecture can be used to process RGB and depth images simultaneously captured in the surgical environment (e.g., distal femur, proximal tibia and patella concurrently) in real-time using a commercially available RGB-D camera. FIG. 5 depicts an illustrative RGB-D imaging sensor 500 that is a component of a tracking system 115. For example, the RGB-D imaging sensor 500 can be the Smith and Nephew, Inc. SpryTrack. U.S. patent application Ser. No. 17/431,384 discloses systems and methods for optical tracking with an illustrative RGB-D imaging sensor 500 and is incorporated herein by reference in its entirety. Other example imaging sensors 500 include the Azure Kinect DK developer kit from Microsoft Corporation and the Acusense camera from Revopoint 3D. The deep neural network can be trained using either mono-modal (i.e., RGB) or multi-modal (i.e., RGB-D) techniques. In some examples, the segmented images can be used for femur, tibia, or patella registration in computer-assisted knee replacement without the need for invasive markers.

The mono-modal approach can include localizing and segmenting the target arca using only RGB images in order to extract the surface geometry of the target bone. Alternatively, the multi-modal approach can include localizing the target anatomy using the RGB images and segmenting the target area of the corresponding depth image, from which the surface geometry of the target bone can be extracted to increase model performance. The model performance can be expressed in terms of a Dice score.

The deep learning model can perform binary (i.e., single output) or multiclass (i.e., n-output) classification depending on whether the surgical procedure uses either a U-Net, E-Net or W-Net architecture, respectively. A W-Net model, which comprises two concatenated U-Net architectures has the advantage of higher validation accuracy and improved depth estimation. In a W-Net model, a first U-Net architecture may function as an encoder that generates a segmented output for an input image (e.g., RGB or depth map). The second U-Net architecture in a W-Net model may use the segmented output to reconstruct the original input image. The approach can allow 2D-RGB image segmentation and 3D point cloud registration to be optimized simultaneously under real-world occlusion caused by intraoperative interventions.

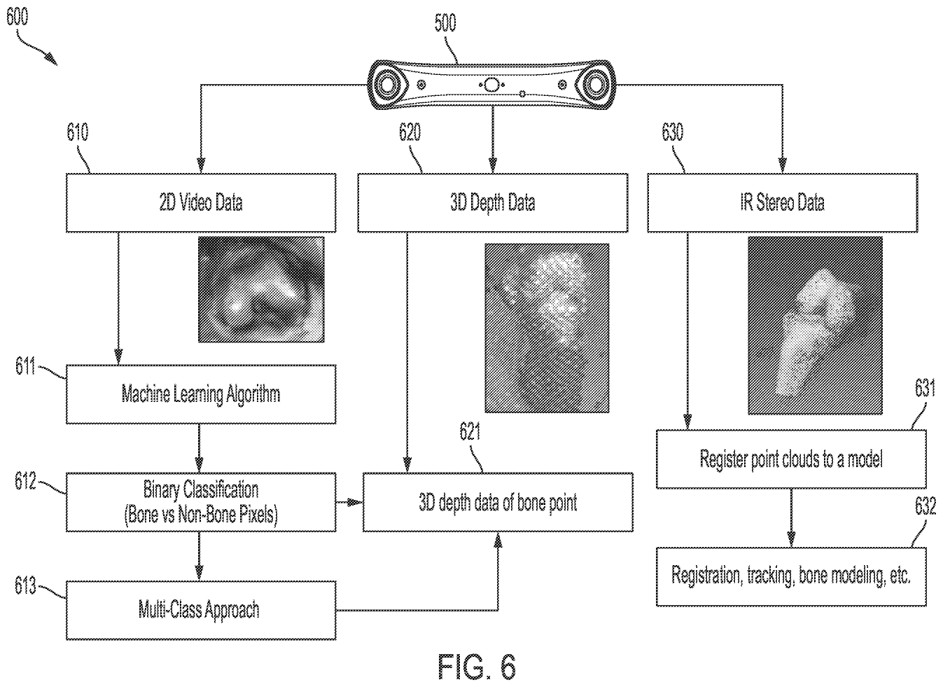

Referring to FIG. 6, a dual mode functionality 600 of an RGB-D imaging sensor 500 is depicted in accordance with an embodiment. The RGB-D imaging sensor 500 can include one or more cameras designed to acquire infrared camera images, as well as, to detect and track fiducials (e.g., reflective spheres, disks and/or IR-LEDs) with high precision. In some embodiments, the RGB-D imaging sensor 500 can provide the 3D positions of fiducials and/or the poses of markers. In further embodiments, the RGB-D imaging sensor 500 can retrieve structured-light images for dense 3D reconstruction. A high mapping frequency of the RGB-D imaging sensor 500 can enable tracking the target bone in real time without the need for markers.

The RGB-D imaging sensor 500 can include three output signals including 2D video data 610, 3D depth data 620, and infrared (IR) stereo data 630. The IR stereo data 630 can be processed to register point clouds to a model 631 (e.g., based on patient data and/or an atlas model). The registered point clouds 631 can be used for registering other objects, tracking, and/or modeling 632. In some embodiments, the 2D video (RGB) data 610 is processed using a machine learning algorithm 611 to produce a binary classification of each pixel 612 (e.g., is the pixel bone or non-bone). In further embodiments, the 3D depth data 620 is processed to identify the depth of each bone point 621, based on the binary classification 612. A combination of the 3D bone depth 621 and the binary classification can allow for a multiclass approach 613 (e.g., classifying a pixel as belonging to an identified bone).

Referring back to FIG. 1, the RGB-D imaging sensor 116, as part of the tracking system 115, can be located on a pendant arm above the patient. In an embodiment, the distance between the RGB-D imaging sensor 116 and the anatomy of the patient 120 is approximately 80 cm, which represents a beneficial position for depth map reconstruction and image resolution.

In an alternative embodiment, a miniature RGB-D imaging sensor 116 can be mounted to the robotic arm 105A. Markerless tracking can be used to guide movement of the robotic arm 105A towards a target point on the bone surface and measure a position of the robotic arm 105A. Deep learning-based algorithms can be used to segment the anatomy from real-time RGB-D frames. A preoperative patient-specific model can then be registered to the detected points, and the current anatomy pose can be displayed to the surgeon in a virtual environment. A target position and orientation on the anatomy surface can be selected preoperatively and a virtual visuo-haptic guide can be placed on the model. Movements of the tool can be controlled by the surgeon through an interface, which can also provide active force feedback when the tool touched the virtual guide, helping the surgeon reach the desired pose.

In another embodiment, a miniature RGB-D imaging sensor 116 is rigidly attached to a robotic-controlled handpiece using an adaptor. The adaptor can negate the need for independent tool tracking. The adaptor can be 3D printed. In an embodiment, the adaptor can position the RGB-D imaging sensor 116 approximately 36 cm from an instrument tip. The position of the tool relative to the patient can be automatically computed. In some embodiments, the system can be rigidly fixated so that marker and RGB data can be acquired in sequence. The adapter created for the handpiece can allow dynamic registration during cutting while reducing line-of-sight issues in the operating environment. The tool-mounted configuration may optimize the quality. of 3D reconstruction and the density of points in the region of interest.

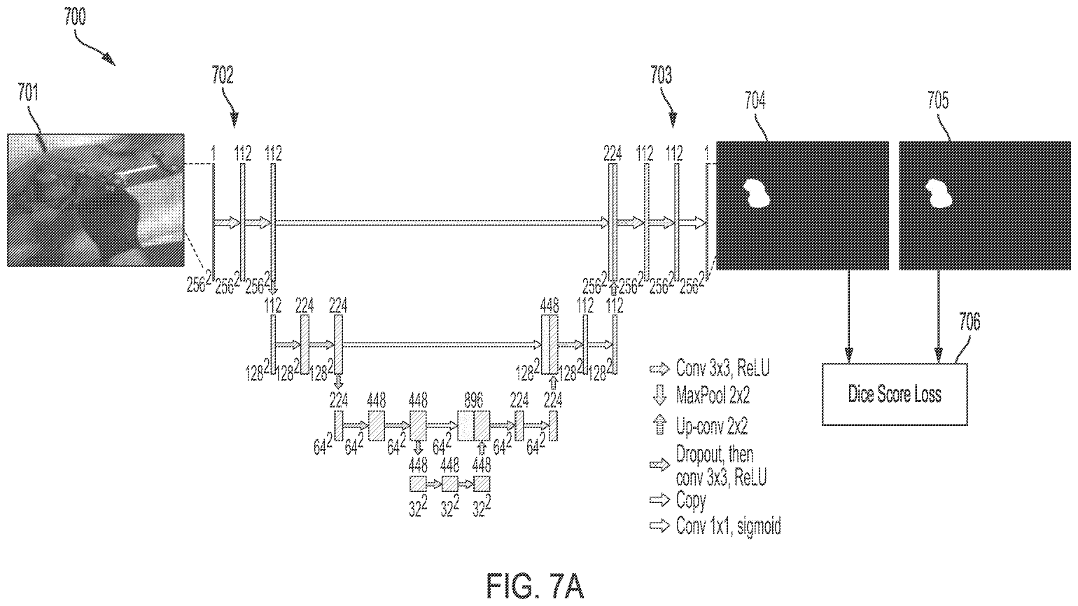

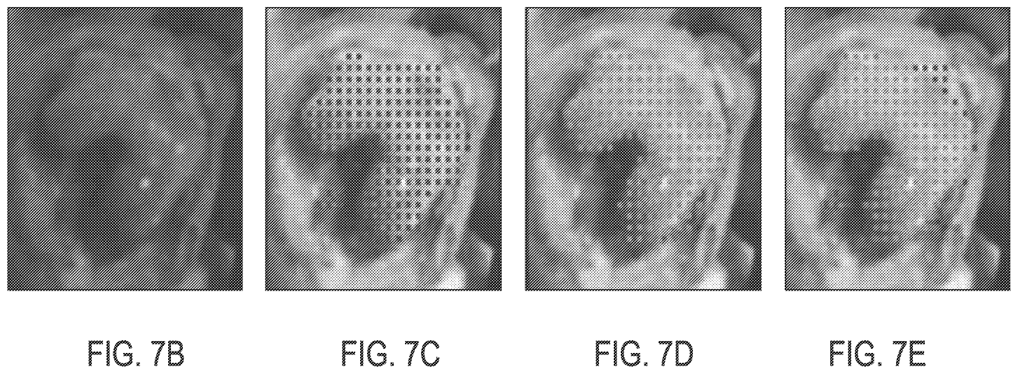

FIG. 7A illustrates a binary classification neural network 700, based upon a U-Net architecture in accordance with an embodiment. The neural network 700 can be trained from deep learning algorithms for auto-segmenting bone from non-bone pixels within a surgical exposure site. RGB images 701 can be used as the input. The images 701 can be progressively downsampled and the features can be extracted in the encoder phase 702, and progressively upsampled in the expanding path 703 to generate a segmentation mask 704 of the same size as the input 701. The output with one channel (e.g., 0 or 1) can correspond to the predictions from the neural network 700. The segmentation mask 704 can be evaluated by determining a Dice score loss 706. The Dice score loss 706 can be determined by comparing the segmentation mask 704 with ground-truth data 705 obtained from either an intra-operative point cloud or pre-operative CT scan. The evaluation 706 can be fed back into the network 700 to improve accuracy. In an embodiment, the neural architecture can be used to assist with robot-assisted patellofemoral joint (PFJ) registration, whereby the segmentation mask 704 corresponds to the distal femur.

FIGS. 7B-7E depict a series of images images illustrating the segmentation process for the distal femur based on the binary classification neural network 700. FIG. 7B depicts the input image. FIG. 7C depicts the predicted segmentation mask, FIG. 7D depicts a mask based on ground-truth data. FIG. 7E depicts the overlay between the predicted segmentation mask of FIG. 7C and the ground-truth mask of FIG. 7D.

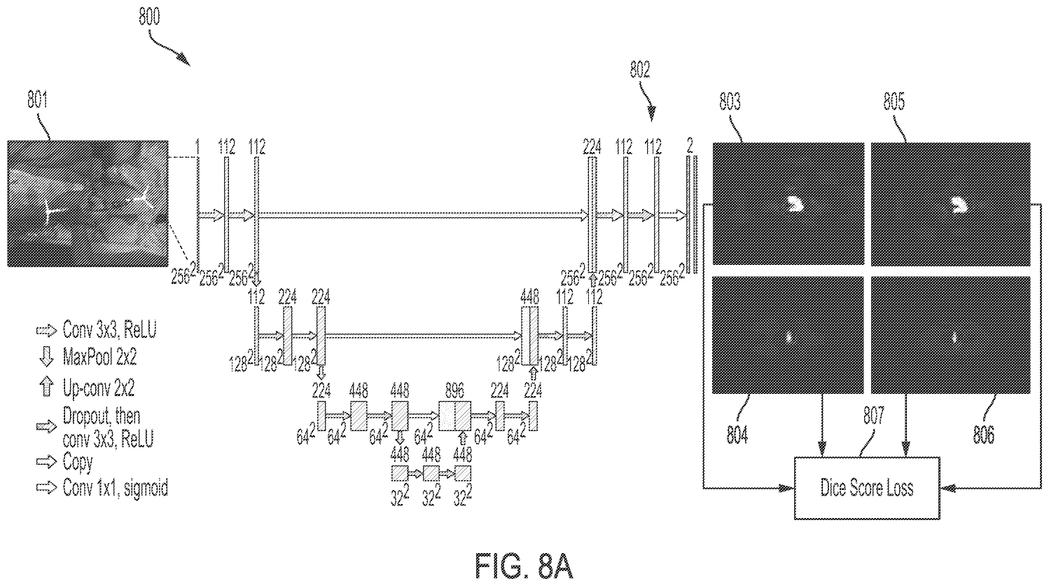

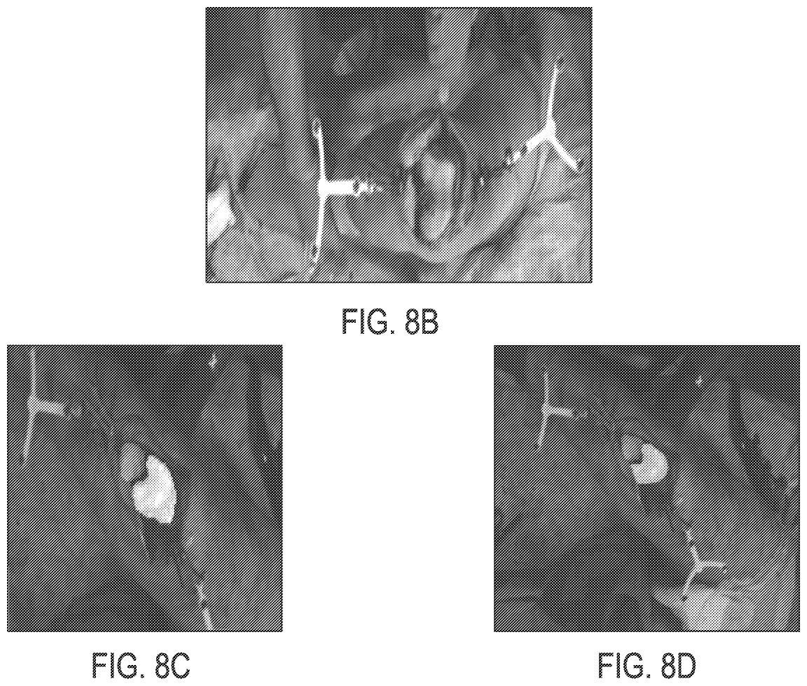

FIG. 8A depicts a multi-class classification neural network 800 based upon the same architecture, as described in reference to FIG. 7A, for the binary classification U-Net architecture. In some embodiments, a multi-class classification neural network 800 can be trained from deep learning algorithms for auto-segmenting multiple bone structures from non-bone pixels within a surgical exposure site (e.g., a knee joint). RGB imagery 801 may be used as an input. The output 802 may comprise multiple classes/channels corresponding to the predicted segmentations from the neural network 800. In this example, the segmentation masks correspond to the distal femur 803 and proximal tibia 804. The segmentation masks 803/804 may be evaluated by computing a Dice score loss 807. The Dice score loss 807 may be determined by comparing the segmentation masks 803/804 with corresponding ground-truth data 805/806, pertaining to the class, obtained from either an intra-operative point cloud or pre-operative CT scan. The evaluation 807 can be fed back into the network 800 to improve accuracy. In some embodiments, the neural architecture 800 can be used to assist with more complex surgical planning (e.g., robot-assisted total knee replacement surgery (TKA) registration).

FIGS. 8B-8D depict a series of images illustrating the segmentation process for the distal femur and the proximal tibia, based on the multi-class classification neural network 800. FIG. 8B depicts the input image of a distal femur and proximal tibia. FIG. &C depicts the predicted segmentation masks, individually segmenting the distal femur and the proximal tibia. FIG. 8D depicts masking based on ground-truth data for both the distal femur and the proximal tibia.

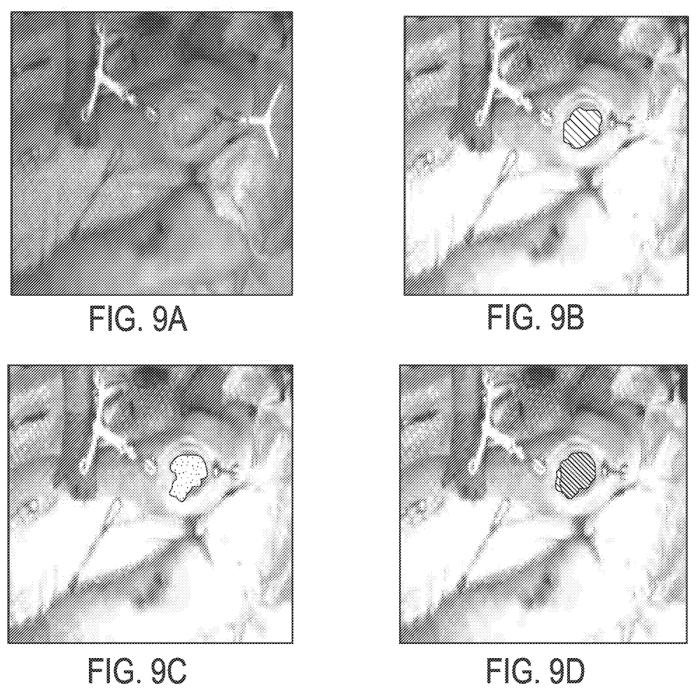

FIGS. 9A-9D depict a series of images illustrating the segmentation process for the patella, based on the multi-class classification neural network 800. The multi-class classification network 800 can enable the anterior and posterior surfaces to be automatically segmented. FIG. 9A depicts the input image of the patella. FIG. 9B depicts the predicted segmentation mask. FIG. 9C depicts masking based on ground-truth data. FIG. 9D depicts an overlay comparing the predicted segmentation mask and the mask based on ground-truth data.

The segmentation methods, as described herein, can be used in a layered approach, For example, an image may initially be segmented to locate a region of interest. The region of interest can include a specific detected object (e.g., the femur, tibia, or patella). The region of interest can include a bounding box determining a border of the region of interest. Alternatively other bounding shapes, or a border directly around the detected object can be used. The region of interest can be further segmented. Through detection of a region of interest, the image field-of-view can be reduced. Additionally, the resolution of the region of interest can be enhanced within the model.

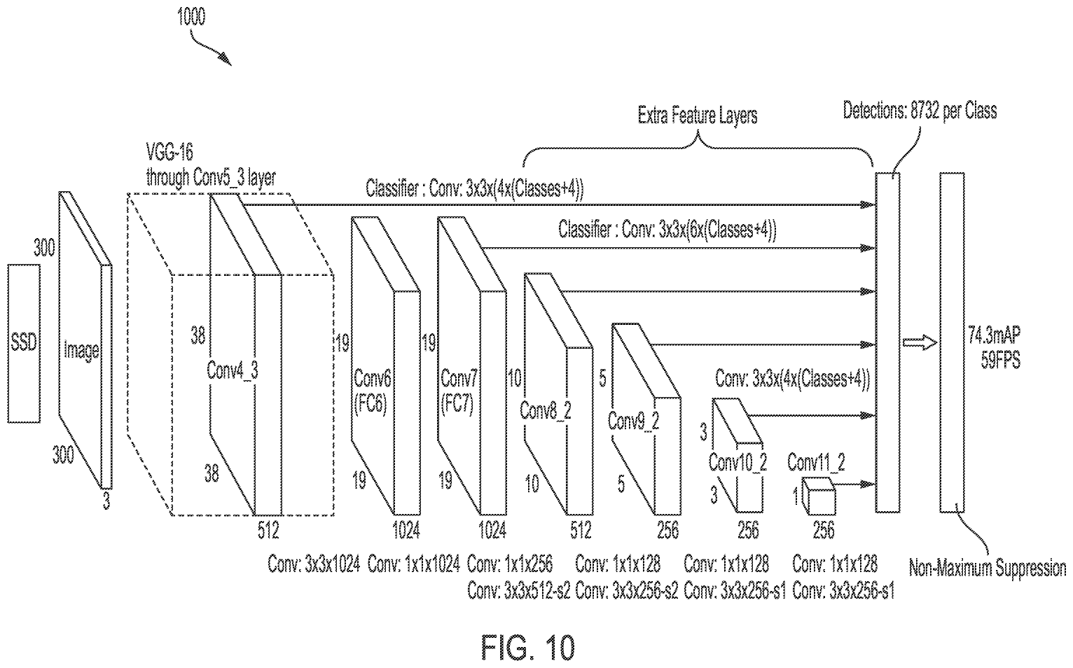

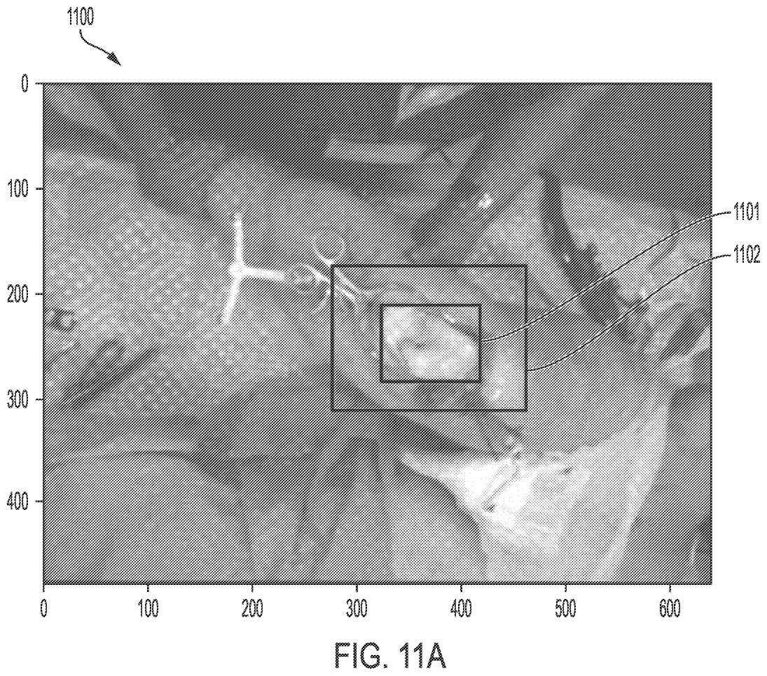

FIG. 10 illustrates a short-listed objection detection model 1000 in accordance with an embodiment. The model 1000 can include a similar feature extraction layer 1000 as a U-Net architecture. The model 1000 can include multi-scale feature analysis at different scales. The model 1000 can include a processing step to select the box with the highest evaluation metric. In some embodiments, the processing step includes non-maximum suppression. In some embodiments, the model 1000 requires the following inputs: an RGB image, a region of interest (e.g., bounding box coordinates) of the target, and a classifying label (e.g., knee class). The region of interest and/or the classifying label can be automatically determined by the system using the methods described herein.

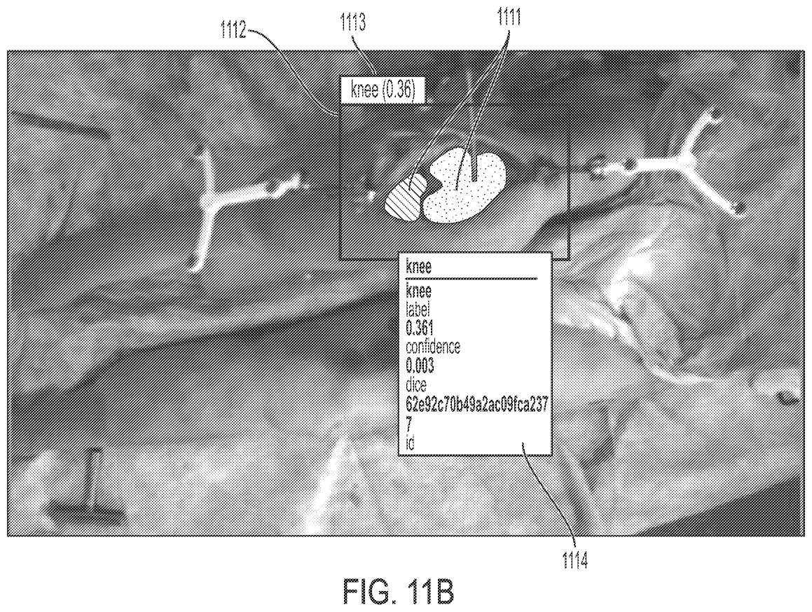

FIG. 11A illustrates automatic ground truth generation for knee detection 1100 in accordance with an embodiment. An automatic ground truth bounding 1101 can be produced through offset to allow for registration error, The offset can guarantee the entire knee region is within the bounds. The offset can include changes to the width and/or height of the bounding 1101. The automatic ground truth bounding 1101 can be used to validate the model to produce near perfect bounding boxes 1102.

FIG. 11B depicts an example real-time display of a knee in accordance with an embodiment. The display can include one or more classified bones. The display can include a bounding box 1112 for a region of interest. The region of interest can include a classifying label 1113. The display can provide certain information relevant to the classification of the bones or the bounding box 1114. The information can include the classifying label, confidence scores, Dice scores, and logging information. In some embodiments, the logging information can associate a registered element with an element identified in preoperative imagery and/or models.

Data from a segmentation can be used to generate a heatmap. The heatmap can illustrate a magnitude of certainty that each pixel belongs to a specific classification. In a multi-class approach, a heatmap can include an overlap of a plurality of classifications for a given pixel either due to uncertainty or a feature belonging to multiple classifications.

In some embodiments, markerless registration, as described herein, can be adapted such that landmarks can be localized (i.e., the landmarks do not need to be palpated/digitized with a probe). Typically, small errors in a landmark detection step can lead to significant errors in later steps in a procedure (e.g., implant positioning). Localization of landmarks can also suffer from inter-and intra-observer variability. In some embodiments, localization can be performed in real-time. A person of ordinary skill in the art will recognize that a binary mask may not be suitable for landmark localization because multiple landmarks may feature overlapping regions.

Anatomical landmarks can be specific 3D points, lines or contours in the anatomy that serve as reference for the surgeon. Example landmarks associated with the patella, which can be classified, include the patella centroid and poles Example landmarks associated with the femur, which can be classified, include Whiteside's line, knee center, hip center, epicondylar line, and anterior cortex. Example landmarks associated with the tibia, which can be classified, include the ankle center, knee center, anterior-posterior cortex, medial third tuberosity, and plateau points. In the intra-operative manual acquisition process, landmarks represented by a point (e.g., the knee center) can be obtained by marking the position of the landmark on the bone with the tip of a point probe. For landmarks represented by lines (e.g., Whiteside's line, AP axis, etc.), the probe can be aligned with the line's direction.

In some embodiments, the success of imageless TKA surgical navigation can greatly depend on the location of relevant anatomical landmarks. Video-based RGB navigation can be used for the landmark acquisition step in imageless navigation. Furthermore, automatic landmark computation can decrease the surgical error and variability, as well as reduce surgical time. In some embodiments, the network can be trained individually for each landmark because some of the landmarks are located in the same pixels (e.g., the knee center of the femur with Whiteside's line).

Imageless automatic landmark detection can include a 2D landmark detection algorithm that comprises a deep learning segmentation architecture to determine a region of the landmark that is then regressed to a point/line in a post-processing step. In some embodiments, an interest region can be extracted to conduct the landmark detection, instead of using the whole image, as in the baseline method. The information provided by the excluded region from the exposed bone bounding boxes can be negligible for the task of determining the location of the anatomical key points. Through multi-class segmentation, either refined detection of a single landmark or multiple landmarks can be localized.

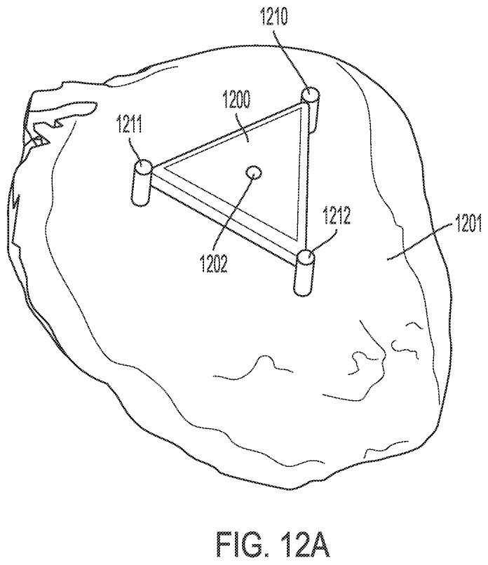

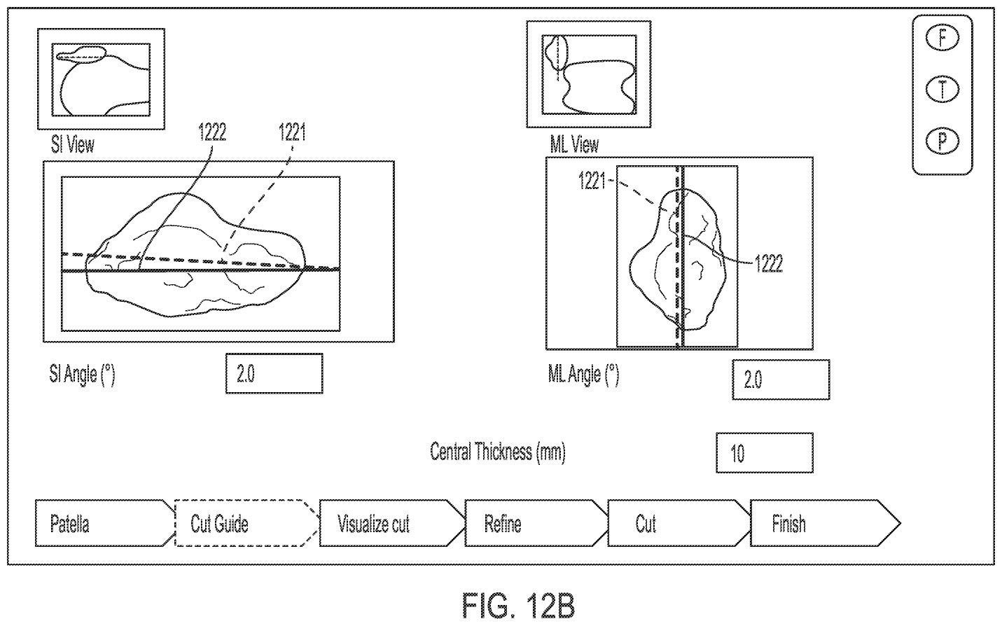

In some embodiments, auto-segmentation of the anterior surface of the patella with an intact retinaculum allows the patellar center to be determined, which is the midpoint between mediolateral and superoinferior extents. The ability to determine suitable contact points on the anterior surface (e.g., base, apex, medial and lateral border) and the centroid enables a visually rectangular cut with equal thicknesses in all quadrants during the patella resection stage. The relationship between the surface's hills and valleys on the anterior surface of the patella and the cutting plane required for patella resurfacing is unknown with standard instrumentation. FIG. 12A illustrates a “best-fit” anterior plane guide 1200 that can be aligned to the desired resection plane positioned at the centroid 1202 determined by the neural network with three pegs, at the inferior point 1210, medial point 1211, and lateral point 1212, centered on the patella 1201 surface. For the resection to be symmetric, the device should be centered on the patella. For example, symmetry measured 15 mm from the patellar extents leaves approximately 16 mm in the center of the patella. A 16 mm spacing about the center is a reasonable estimate of the resection plane. A patient-specific alignment guide can be used for auto-landmarking and flattening the native “irregular” anterior surface to optimize tissue resection (i.e., patella resurfacing).

FIG. 12B depicts a display for aiding in bone removal on the patella in accordance with an embodiment. As described in reference to FIG. 12A, a resection plane can be planned in reference to one or more identifiable landmarks. The display can provide a Superior Inferior (SI) view and/or a Medial Lateral (ML) view of the everted patella relative to the femur. The CASS 100 can automatically display a current saw guide position and orientation 1221 based on any known tracking method in any view. The CASS 100 can further display the planned resection 1222 based on the identifiable landmarks. In some embodiments, the CASS 100 can accommodate right-and left-handed users. In some embodiments, the CASS 100 can accommodate medial or lateral parapatellar incisions. The CASS 100 can plan the thickness of a desired cut and a component size based on the determined centroid of the anterior surface of the patella, via landmark detection.

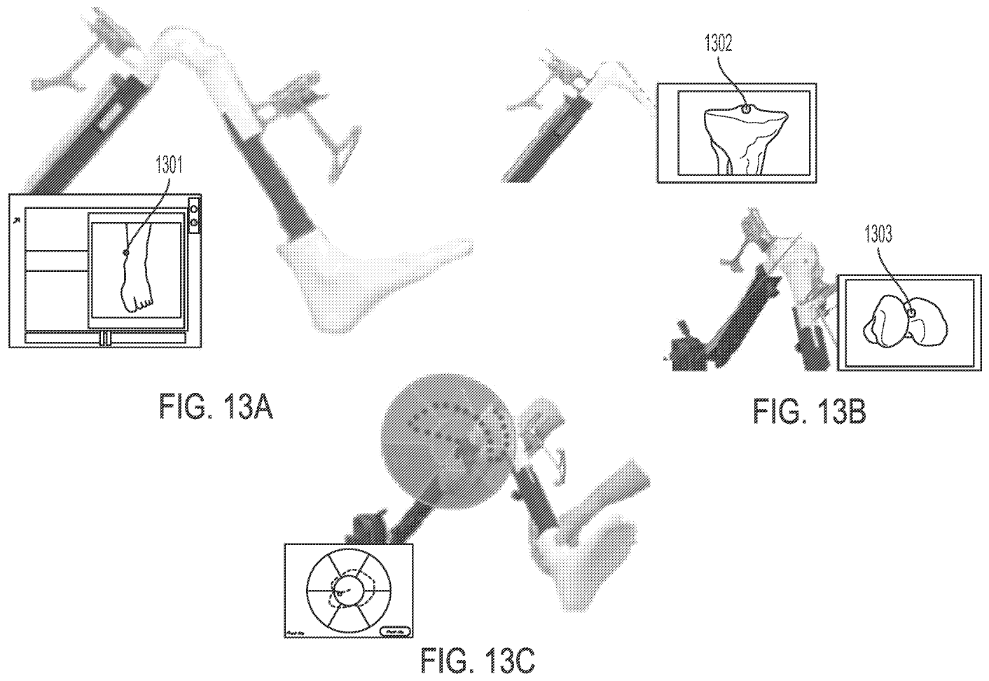

FIGS, 13A-C illustrate other example landmarks which can be automatically localized in a similar manner. FIG. 13A illustrates automatic landmark detection for defining an ankle center 1301. FIG. 13B illustrates automatic landmark detection for defining a knee center 1302/1303. FIG. 13C illustrates automatic landmark detection for defining a hip center. In some embodiments, the hip center is determined with rotational accuracy within two degrees.

In further embodiments, a patient-specific alignment guide can be interfaced to the patient anatomy. The patient-specific alignment guide can be configured to optimize tissue resection. The patient-specific alignment guide can be further configured as an aid for auto-landmarking by providing a known shape for segmentation.

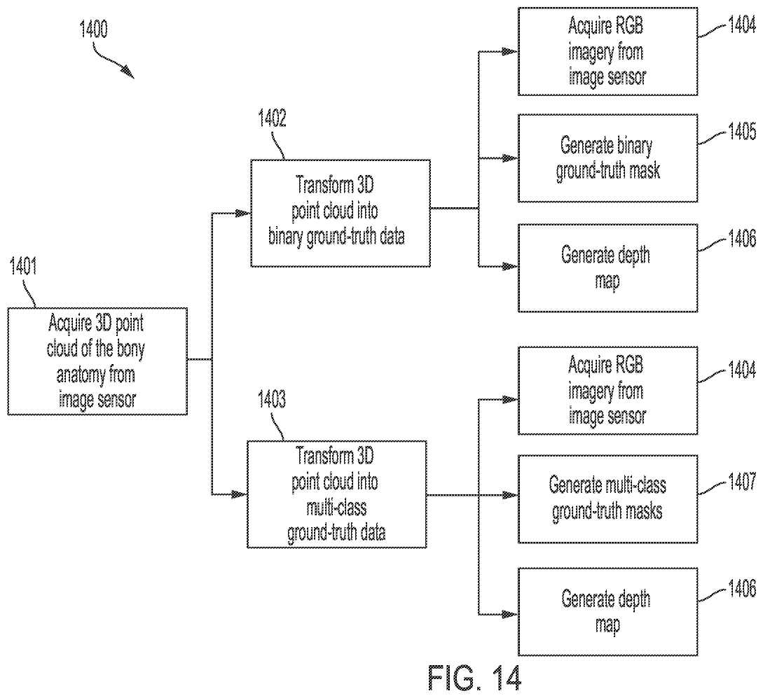

FIG. 14 illustrates a method for automatically generating ground-truth masking for both the binary and multi-class classification networks 1400. In some embodiments, the RGB-D imaging sensor 500 can acquire a 3D point cloud of the bony anatomy 1401 in addition to the RGB imagery 1404. The method can include automatically transforming the 3D point clouds into binary 1402 and/or multi-class 1403 ground-truth data. Projecting the ground-truth data onto the 2D RGB images 1404 can automatically generate binary 1405 and multi-class 1407 ground-truth masks. In some embodiments, the depth information stored in the 3D point cloud can be projected onto the 2D RGB images 1404 to generate a depth map 1406 as a multi-modal approach to increase model performance.

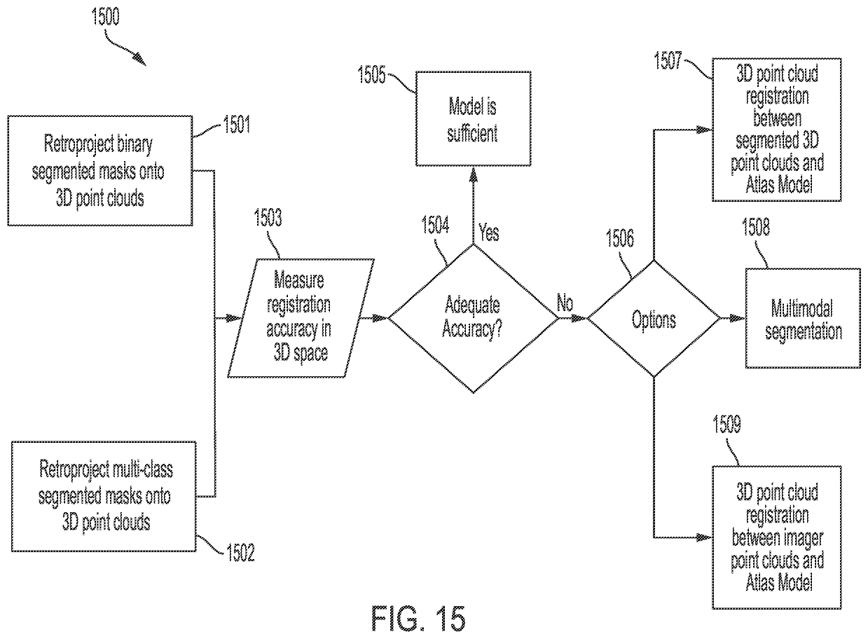

FIG. 15 illustrates strategies for improving the overall accuracy of the auto-segmentation deep learning network, in 3D space, for both the binary and multi-class classification approaches. For example, retroprojecting the 2D binary 1501 or multi-class 1502 segmented masks onto the 3D point clouds derived from a statistical shape model after the initial U-Net fully convolutional network. The retroprojection 1501/1502 can be compared to the 3D point clouds to measure registration accuracy in 3D space 1503. If the comparison meets a threshold for accuracy 1504 then the model is sufficient 1505. If the comparison does not meet a threshold for accuracy 1504, then three example options 1506 for improving accuracy are presented. A first example option 1507 includes 3D point cloud registration between the segmented 3D point clouds and a known atlas model of the anatomy to produce a potentially more accurate representation. A second example option 1508 includes multimodal segmentation based on the generated depth map 1406. A third example option 1509 includes 3D point cloud registration between the RGB-D imaging sensor 3D point clouds and a known atlas model of the anatomy to produce a potentially more accurate representation.

Another technique for improving model performance includes post-processing the raw generated ground-truth data using image processing. For example, the Matlab tool imclose enables morphological closing of the image. Alternately, the Matlab tool imfill reduces the number of voids within the region of interest in the ground-truth mask. Post-processing can ensure that the two sets of point clouds are aligned within the same reference space. A further technique includes addressing the boundary regions surrounding the masks, which are more problematic to segment. The segmentation of these boundary pixels can be improved by implementing single and combined loss functions (e.g., Dice score with TopK loss, focal loss, Hausdorff distance loss, and boundary loss) that are appropriately weighted to avoid over-estimating these boundary points.

In another embodiment, an RGB-D segmentation U-Net network architecture can be created with two twin input branches and one decoding branch. The overall accuracy of the auto-segmentation deep learning network in the 3D space can be improved for both the binary and multi-class classification approaches by combining the RGB and depth images. In the encoding phase, features are extracted from the RGB and depth images, and the fusion models, based on both images, can be used to reconstruct the final segmentation masks. The depth maps are less susceptible to surgical illuminations and can therefore result in an increase in model performance.

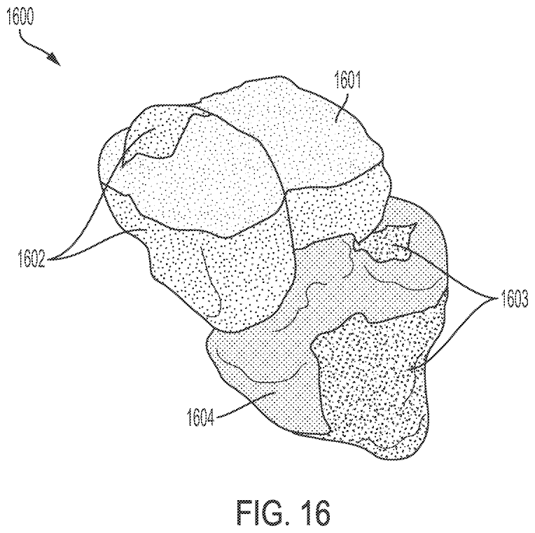

FIG. 16 illustrates the application 1600 of 2D segmentation in 3D registration. The femur 1601 and tibia 1604 segmentation maps are retroprojected into 3D space, and the registration between those two sets of 3D point clouds is combined with corresponding statistical shape (i.e., reference) models 1602/1603. The application 1600 can use alternative deep learning approaches (e.g., 3DMatch Toolbox) to compute the transformations. In some embodiments, the network architecture may be the W-Net model.

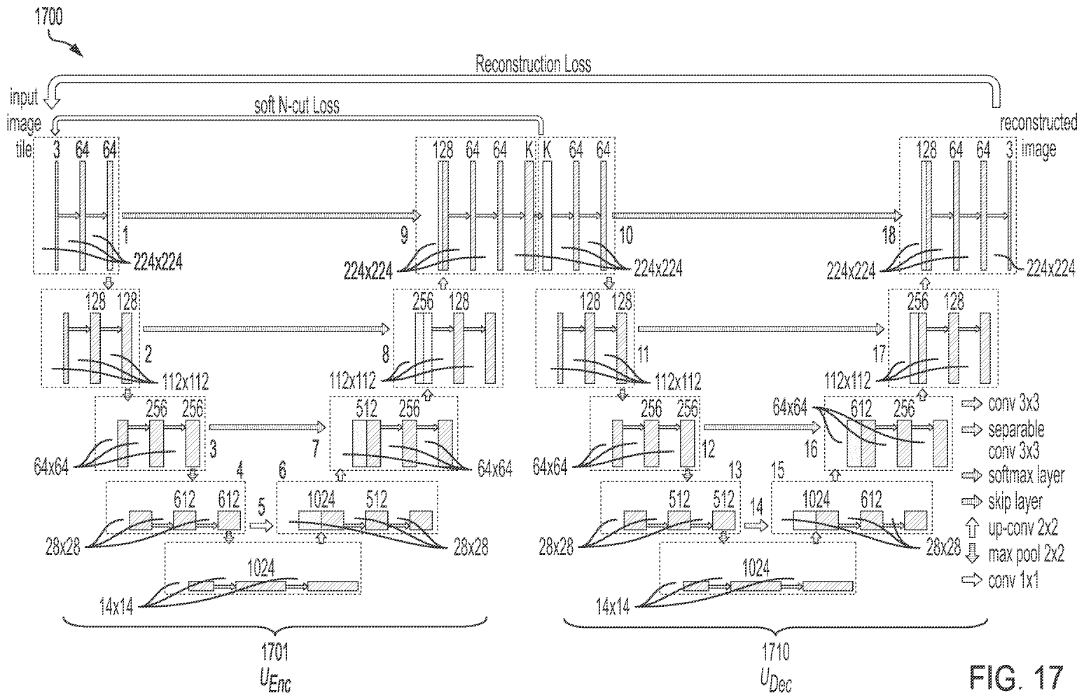

FIG. 17 illustrates a W-Net model 1700. As shown in FIG. 17, the output of the first sub-network 1701 can be used as the input for the subsequent sub-network 1710. The first sub-network 1701 may function as an encoder that outputs image segmentations from the unlabeled original images. The subsequent sub-network 1710 may function as a decoder that outputs the reconstruction images from the segmentations. As a result, the 2D RGB image segmentation and 3D point cloud registration can be optimized together.

In another embodiment, the segmented bone masks may be registered to either a pre-operative 3D model or a previously computed intra-operative 3D model of the bone and either stored to file or used as input to an atlas model. In another embodiment, the 3D point clouds obtained from the RGB-D imaging sensor 500 may be segmented with the point clouds obtained from a statistical shape model using an open-source library of computer vison algorithms (e.g., Learning3D).

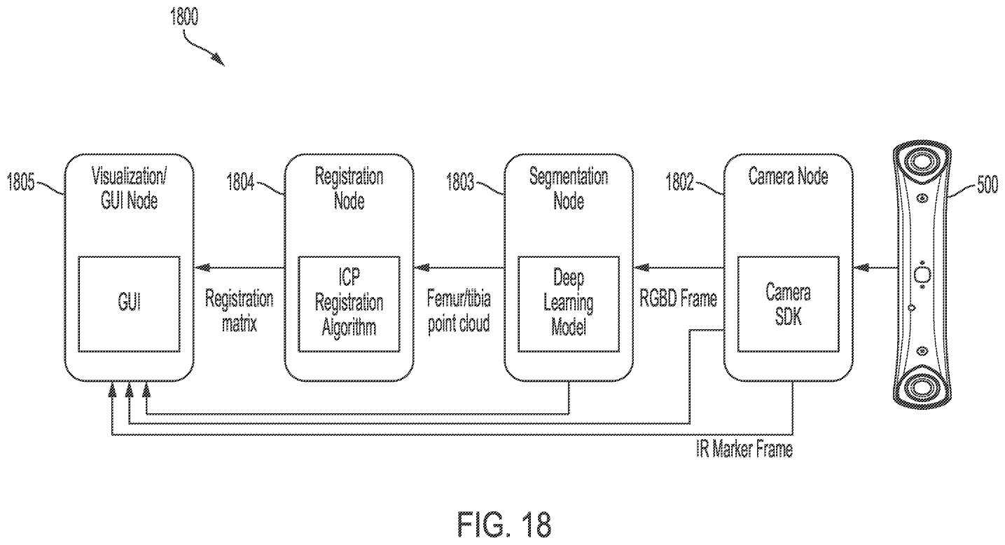

FIG. 18 illustrates a real-time registration architecture 1800 used for accuracy testing in accordance with an embodiment. The architecture 1800 features a communication framework that allows each of the nodes (e.g., the RGB-D camera 1802, segmentation 1803, registration 1804, and visualization 1805) to communicate with the other nodes. In an embodiment, the architecture 1800 can be based upon the Robot Operating System (ROS), which is a set of open-source software libraries and tools that help construct applications and reuse code for robotics applications. In some embodiments, the visualization node 1805 can be implemented in C++. In some embodiments, the camera 1802, segmentation 1803, registration 1804 nodes can be implemented in Python. The camera node 1802 can include an SDK to interface with the camera 500. The camera node 1802 can stream data (i.e., RGB frames and depth data) to the segmentation node 1803. The segmentation node can produce labeled masks of the RGB frames and send them to the registration node 1804. The registration node 1804 can compute the registration, The visualization node 1805 presents the data for display on an interface (e.g., a graphical user interface). The camera 1802, registration 1804, and visualization 1805 nodes can be generic across multiple types of procedures. The segmentation node 1803 can be specific to a type of procedure based on training data used.

An example test bed running the registration algorithm on the ROS architecture achieved a total processing time of approximately 150 ms from data collection to visualization. Segmentation time was approximately 25 ms per frame including 12 ms of networking. Registration time was approximately 20 ms per frame. These values could be enhanced through improvements to the test system.

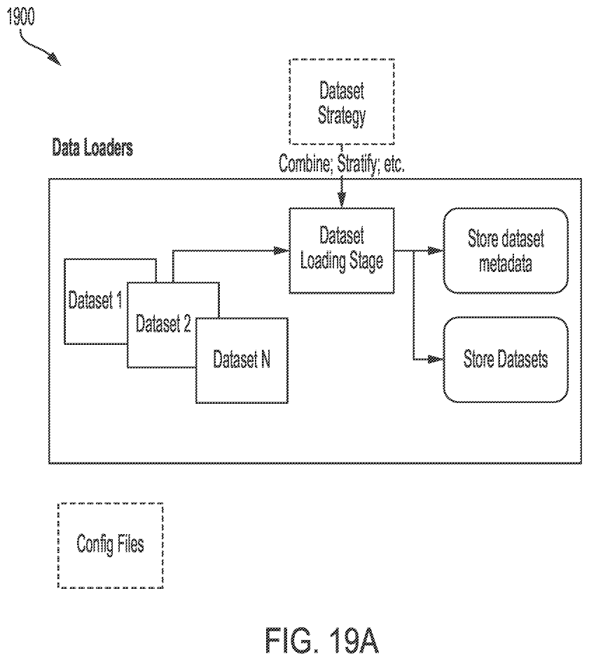

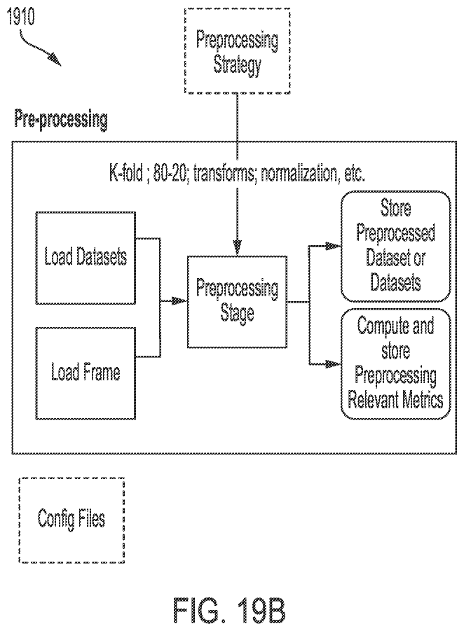

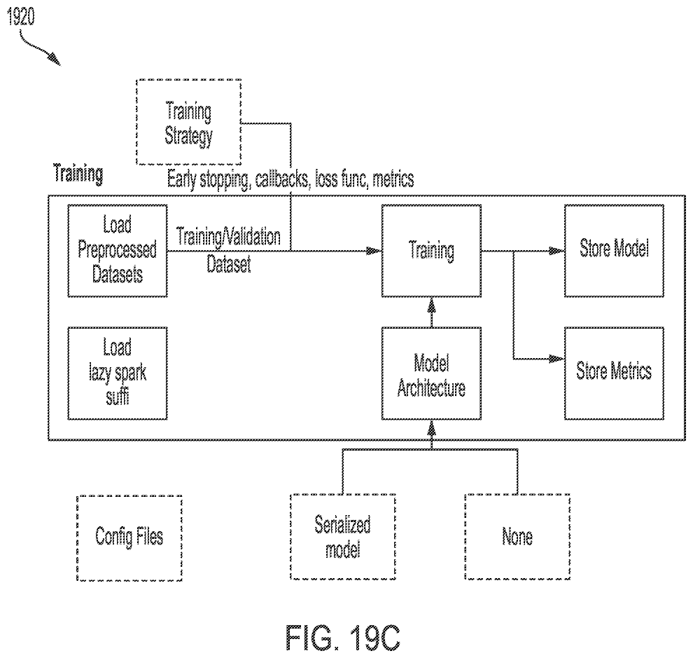

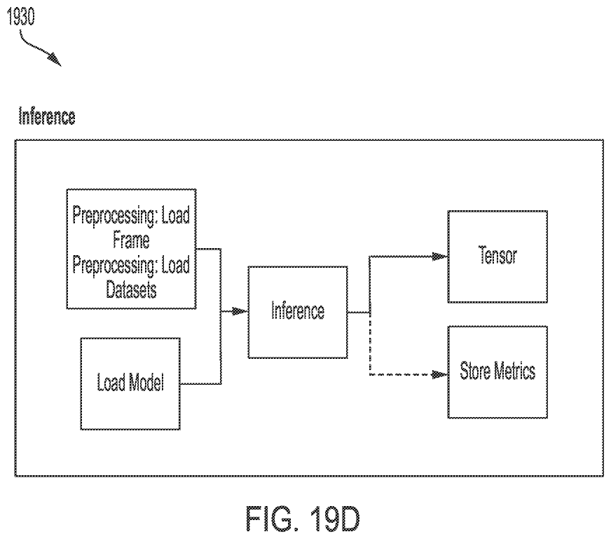

FIGS, 19A-D illustrate a real-time registration hierarchical architecture for the deep learning pipeline. The example architecture is based upon an open-source python-based software (e.g., Hydra). In an embodiment, the pipeline may include four independent stages. FIG. 19A illustrates the first stage, data loaders 1900. FIG. 19B illustrates the second stage, pre-processing 1910. FIG. 19C illustrates the third stage, training 1920. FIG. 19D illustrates the fourth stage, inference 1930. Once the camera sees the exposed target, the pixels associated with the target can be automatically segmented from the RGB-D frames by trained neural networks. The segmented surface can be registered to a reference model in real time to obtain the target pose.

### Example—Dice Box Plots

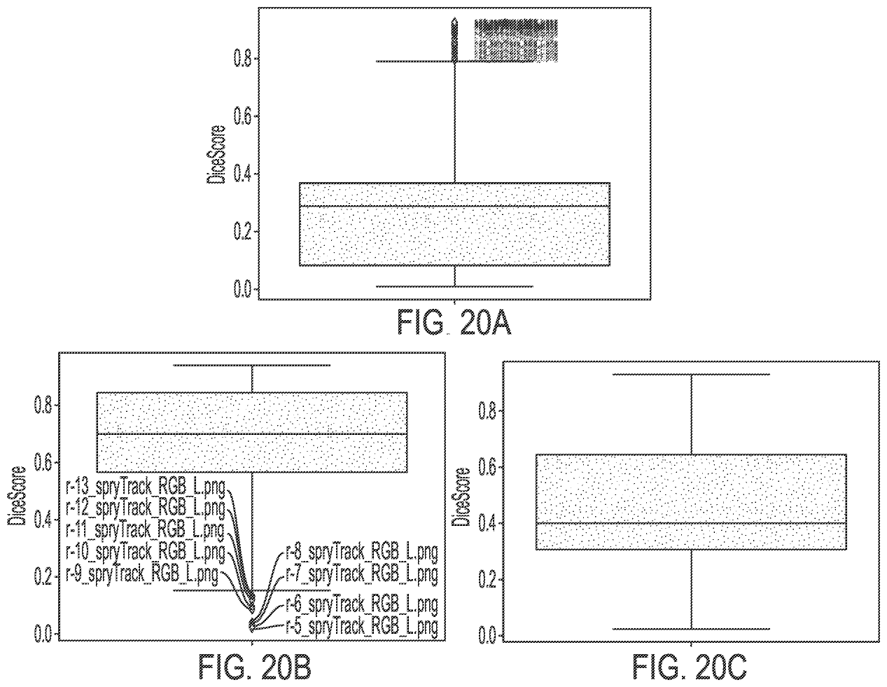

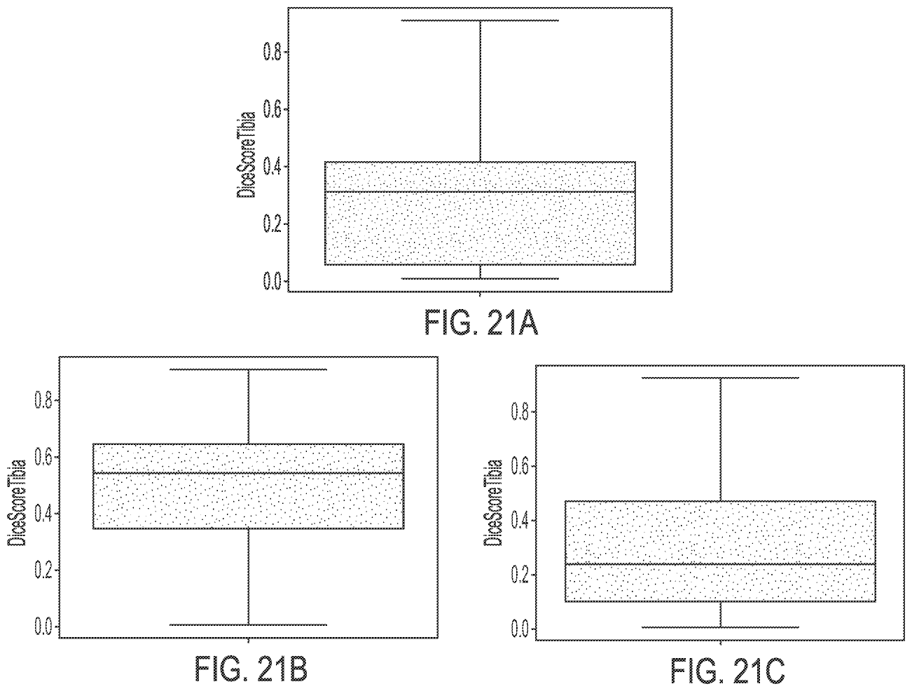

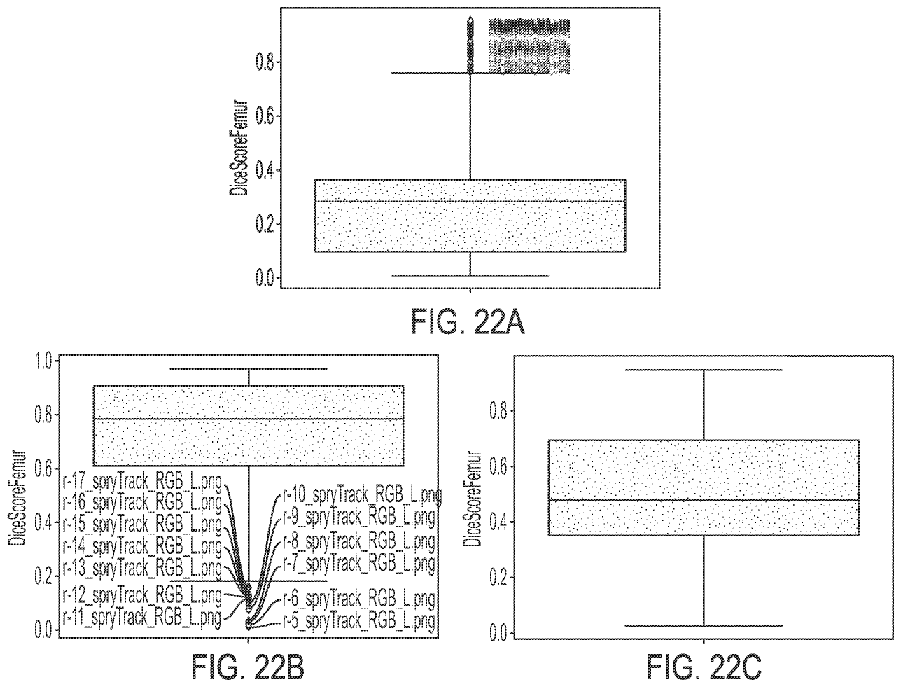

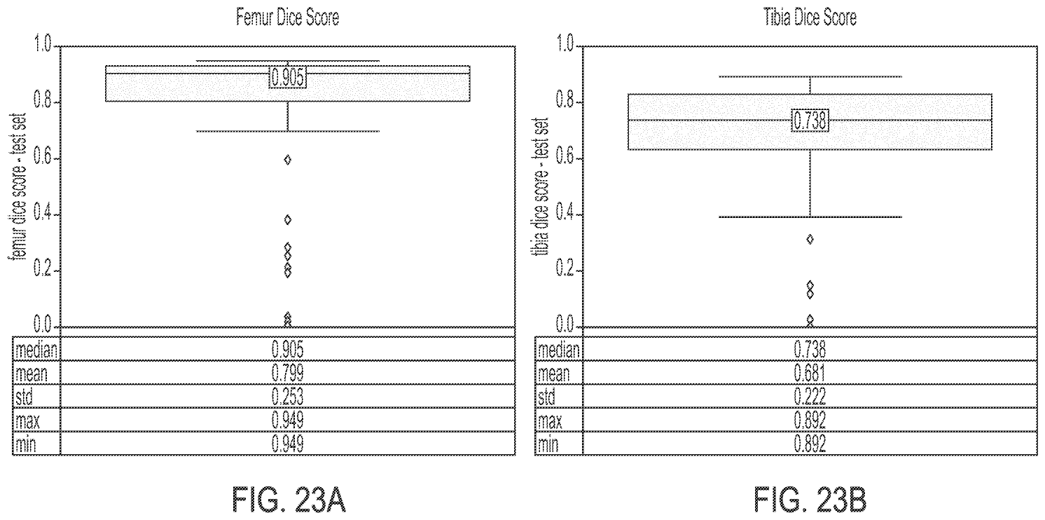

Dice score loss is a metric for determining the performance of the neural network model. K-fold cross-validation is a strategy that repeats the process of randomly splitting the data set into training and test set times. FIGS. 20A-25B depict illustrative Dice box plots highlighting the average scores per fold obtained from the multi-class architecture for various segmentations. FIGS. 20A-C depict Dice box plots, from three example folds, obtained from the multi-class architecture to perform a combined femur and tibia segmentation. FIGS. 21A-C depict Dice box plots, from three example folds, obtained from the multi-class architecture to perform tibia segmentation. FIGS. 22A-C depict Dice box plots, from three example folds, obtained from the multi-class architecture to perform femur segmentation. A Dice coefficient typically ranges between zero and one. A score of one corresponds to a pixel perfect match between the deep learning model output and ground-truth annotation. In the examples, higher mean Dice scores were typically observed with the femur segmentation and ranged from 0.3 to 0.8.

FIGS, 23A and 23B depict Dice box plots for the femur and tibia, respectively, where the model was overfitted by manually annotating images to improve data labeling in subsequent automatic ground-truth generation.

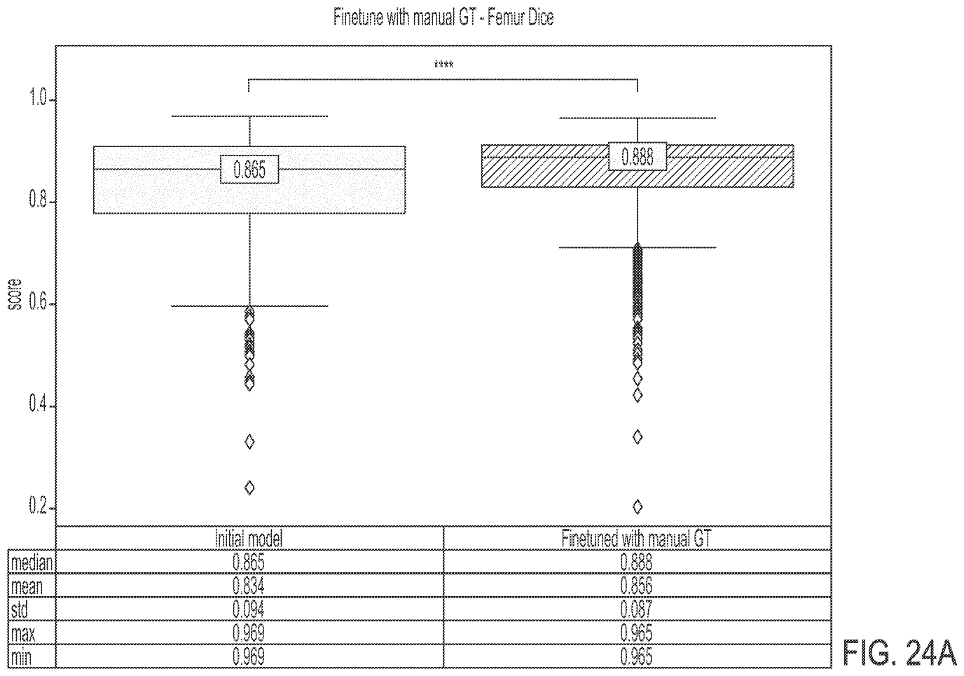

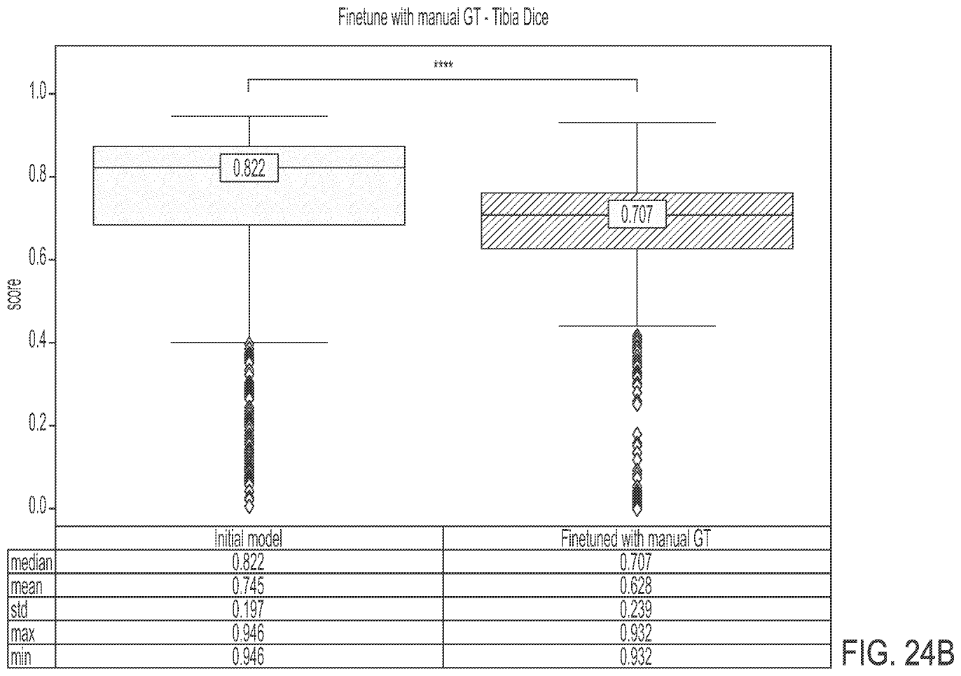

FIGS. 24A and 24B depict Dice box plots for the femur and tibia, respectively. In both cases, an initial model and a model fine-tuned with manual ground-truths are compared.

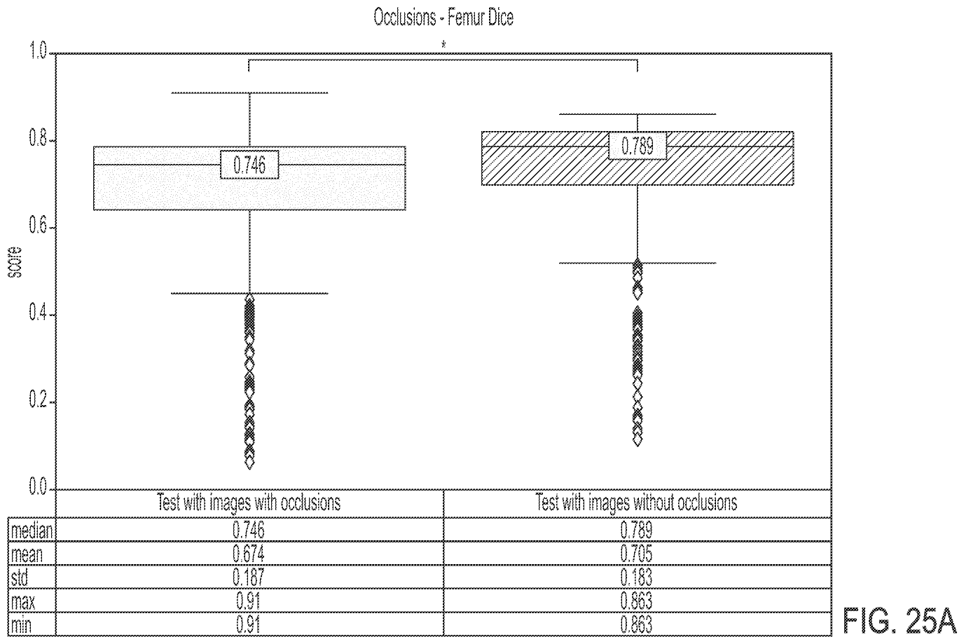

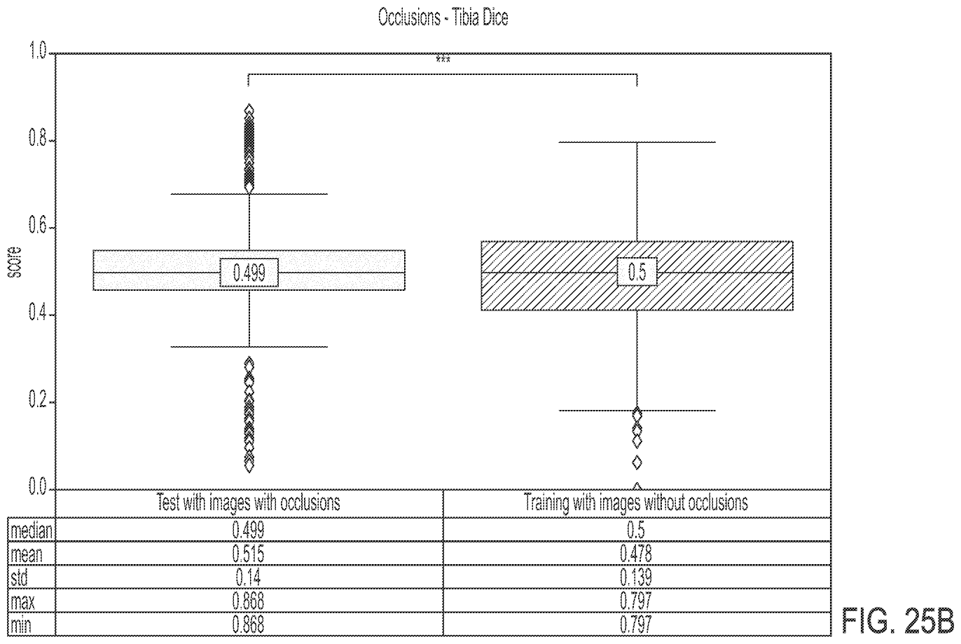

FIGS. 25A and 25B depict Dice box plots for the femur and tibia, respectively. In both cases, the model is tested with images featuring occlusions and images without occlusions. The model performed similarly with only a minor improvement when the images lacked occlusions.

Lower mean Dice scores were obtained with the tibia due to the lack of visibility from the camera. Higher variability of accuracy across k-folds may result from an incorrect dataset split leading to overfitting. Variability may be overcome by applying a suitable hyperparameter search to the multi-class architecture, such as data augmentation, and improving the split per acquisition between the dataset in the training and test sets. High false negatives, which can result from the neural network learning from inaccurate data (i.e., over/under segmentation of the ground-truth), can be overcome by fine-tuning with manual segmentation.

### Example Data Processing System

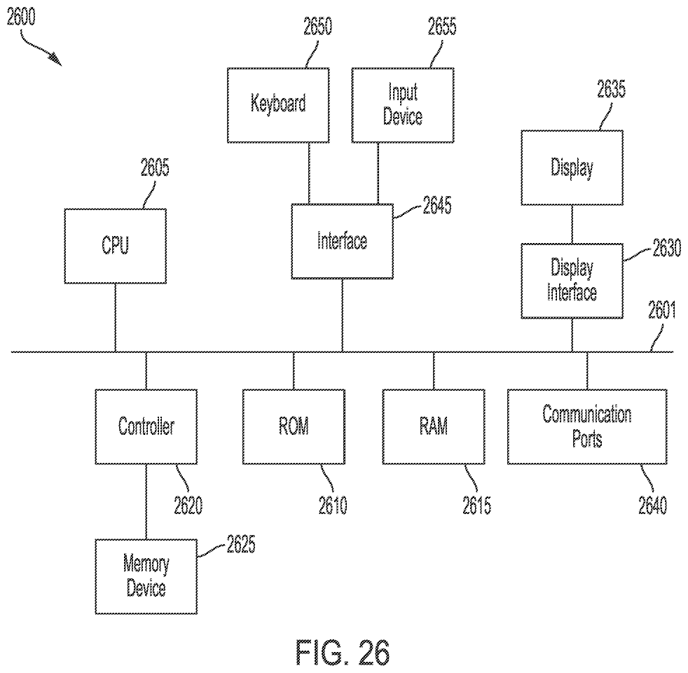

FIG. 26 depicts a block diagram of data processing system 2600 comprising internal hardware that may be used to contain or implement the various computer processes and systems as discussed above. In some embodiments, the exemplary internal hardware may include or may be formed as part of a database control system. In some embodiments, the exemplary internal hardware may include or may be formed as part of an additive manufacturing control system, such as a three-dimensional printing system. A bus 2601 serves as the main information highway interconnecting the other illustrated components of the hardware. CPU 2605 is the central processing unit of the system, performing calculations and logic operations required to execute a program. CPU 2605 is an exemplary processing device, computing device or processor as such terms are used within this disclosure. Read only memory (ROM) 2610 and random access memory (RAM) 2615 constitute exemplary memory devices.

A controller 2620 interfaces with one or more optional memory devices 2625 via the system bus 2601. These memory devices 2625 may include, for example, an external or internal DVD drive, a CD ROM drive, a hard drive, flash memory, a USB drive or the like. As indicated previously, these various drives and controllers are optional devices. Additionally, the memory devices 2625 may be configured to include individual files for storing any software modules or instructions, data, common files, or one or more databases for storing data.

Program instructions, software or interactive modules for performing any of the functional steps described above may be stored in the ROM 2610 and/or the RAM 2615. Optionally, the program instructions may be stored on a tangible computer-readable medium such as a compact disk, a digital disk, flash memory, a memory card, a USB drive, an optical disc storage medium, such as a Blu-ray™ disc, and/or other recording medium.

An optional display interface 2630 can permit information from the bus 2601 to be displayed on the display 2635 in audio, visual, graphic or alphanumeric format. Communication with external devices can occur using various communication ports 2640. An exemplary communication port 2640 can be attached to a communications network, such as the Internet or a local area network.

The hardware can also include an interface 2645 which allows for receipt of data from input devices such as a keyboard 2650 or other input device 2655 such as a mouse, a joystick, a touch screen, a remote control, a pointing device, a video input device and/or an audio input device.

Though many of the examples provided herein, with respect to image segmentation, apply to procedures relating to the knee, one of ordinary skill in the art will recognize that a similar model can be trained for any procedure with similarly visible anatomy (e.g., the shoulder or hip).

While various illustrative embodiments incorporating the principles of the present teachings have been disclosed, the present teachings are not limited to the disclosed embodiments. Instead, this application is intended to cover any variations, uses, or adaptations of the present teachings and use its general principles. Further, this application is intended to cover such departures from the present disclosure that are within known or customary practice in the art to which these teachings pertain.

In the above detailed description, reference is made to the accompanying drawings, which form a part hereof. In the drawings, similar symbols typically identify similar components, unless context dictates otherwise. The illustrative embodiments described in the present disclosure are not meant to be limiting. Other embodiments may be used, and other changes may be made, without departing from the spirit or scope of the subject matter presented herein. It will be readily understood that various features of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various features. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

In addition, even if a specific number is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, sample embodiments, or drawings, should be understood to contemplate the possibilities of including one of the terms, either of the terms, or both terms. For example, the phrase “A or B” will be understood to include the possibilities of “A” or “B” or “A and B.”

In addition, where features of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 components refers to groups having 1, 2, or 3 components. Similarly, a group having 1-5 components refers to groups having 1, 2, 3, 4, or 5 components, and so forth.

The term “about,” as used herein, refers to variations in a numerical quantity that can occur, for example, through measuring or handling procedures in the real world; through inadvertent error in these procedures; through differences in the manufacture, source, or purity of compositions or reagents; and the like. Typically, the term “about” as used herein means greater or lesser than the value or range of values stated by 1/10 of the stated values, e.g., ±10%. The term “about” also refers to variations that would be recognized by one skilled in the art as being equivalent so long as such variations do not encompass known values practiced by the prior art. Each value or range of values preceded by the term “about” is also intended to encompass the embodiment of the stated absolute value or range of values. Whether or not modified by the term “about,” quantitative values recited in the present disclosure include equivalents to the recited values, e.g., variations in the numerical quantity of such values that can occur, but would be recognized to be equivalents by a person skilled in the art.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed:

1. A system for intraoperative multi-class segmentation of a patient's proximal tibia, distal femur, and patella, comprising:
an imaging sensor configured to capture and RGB frame and associated depth data;
a processor; and
a non-transitory, processor-readable storage medium in communication with the processor, wherein the non-transitory, processor-readable storage medium contains one or more programming instructions that, when executed, cause the processor to:
receive the RGB frame and the associated depth data from the imaging sensor,
segment the RGB frame into a predicted segmentation mask, using a deep learning network supported by object detection, by classifying each pixel as belonging to one of the group of proximal tibia, distal femur, patella, or non-boney material of the knee, and
determine a loss based on a comparison between the predicted segmentation mask and a ground-truth mask.

2. The system of claim 1, wherein the imaging sensor is affixed to a static position above the patient.

3. The system of claim 1, wherein the imaging sensor is affixed to a robotically controlled instrument.

4. The system of claim 1, wherein the imaging sensor is affixed to a robot arm end effector.

5. The system of claim 1, wherein the deep learning network is optimized under real-world occlusion scenarios.

6. The system of claim 1, wherein the loss is a Dice score loss.

7. The system of claim 1, wherein the one or more programming instructions further cause the processor to automatically generate the ground-truth mask based on a 3D point cloud.

8. The system of claim 7, wherein the 3D point cloud is based on imagery collected preoperatively.

9. The system of claim 7, wherein the 3D point cloud is based on the depth data collected by the imaging sensor.

10. The system of claim 9, wherein the 3D point cloud is further based on an atlas model.

11. The system of claim 1, wherein the one or more programming instructions, when executed, further cause the processor to locate a bounding around a region of interest, based on the detection based on the segmentation mask.

12. The system of claim 1, wherein the one or more programming instructions that, when executed, cause the processor to segment the RGB frame, using a deep learning network, by classifying each pixel as belonging to one of the group of proximal tibia, distal femur, patella, or non-boney material of the knee further comprises one or more programming instructions that, when executed, cause the processor to classify each pixel as resected or non-resected.

13. The system of claim 1, wherein the one or more programming instructions, when executed, further cause the processor to:
generate a 3D point cloud based on the depth data;
construct a 3D surface of patient anatomy by applying the segmentation to the 3D point cloud; and
determine a pose of at least one of the patient's proximal tibia, distal femur, and patella, by aligning the 3D surface of the at least one of the patient's proximal tibia, distal femur, and patella with at least one of a 3D pre-operative model of the patient or an atlas model.

14. The system of claim 1, wherein the one or more programming instructions, when executed, further cause the processor to automatically determine a location of an anatomical landmark region associated with the proximal tibia, distal femur, or patella.

15. The system of claim 14, wherein the landmark is localized in preoperative imagery.

16. The system of claim 14, wherein the one or more programming instructions that, when executed, cause the processor to determine a location of an anatomical landmark region associated with the proximal tibia, distal femur, or patella further comprise one or more programming instructions that, when executed, cause the processor to:
generate a heat map estimation of the landmark; and
determine a location of the anatomical landmark based on the heat map estimation.

17. The system of claim 14, wherein the one or more programming instructions that, when executed, cause the processor to determine a location of an anatomical landmark region associated with the proximal tibia, distal femur, or patella further comprise one or more programming instructions that, when executed, cause the processor to regress the landmark region into at least one of a point or line.

18. The system of claim 14, wherein the landmark is at least one of: the patella centroid, the patella poles, Whiteside's line, the anterior-posterior axis, the femur's knee center, or the tibia's knee center.

19. The system of claim 14, wherein the one or more programming instructions, when executed, further cause the processor to align at least one of a cut guide or implant based on the location of the landmark.

20. A method of determining a pose of a patient anatomy, the method comprising:
receiving imagery from an imaging sensor, wherein the imaging sensor produces RGB images and associated depth data;
segmenting the imagery based on the patient anatomy visible in the imagery, wherein the segmenting comprises classifying any of a femur, tibia, or patella present in the imagery;
generating a 3D point cloud based on the depth data;
constructing a 3D surface of the patient anatomy by applying the segmentation to the 3D point cloud; and
determining a pose of the patient anatomy by aligning the 3D surface of the patient anatomy with at least one of a 3D pre-operative model of the patient or an atlas model.
